(19) United States
(12) Patent Application Publication
(10) Pub. No.: US 2025/0254515 A1
(43) Pub. Date: Aug. 7, 2025

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN)

(73) Assignee: GUANGDONG OPPO MOBILE TELECOMMUNICATIONS CORP., LTD., Dongguan (CN)

(21) Appl. No.: 19/186,098

(22) Filed: Apr. 22, 2025

Related U.S. Application Data
(63) Continuation of application No. PCT/CN2022/127402, filed on Oct. 25, 2022.

(51) Int. Cl. H04W 8/22; H04L 41/16; H04W 24/08

(52) U.S. Cl. CPC H04W 8/22; H04L 41/16; H04W 24/08

(57) ABSTRACT

Embodiments of this application provide a communications device. The communications device is a first device, the first device includes a processor and a memory, the memory is configured to store a computer program, and the processor is configured to invoke the computer program stored from the memory and run the computer program, to cause the first device to perform transmitting a first message to a second device, where the first message includes first artificial intelligence AI/machine learning ML related capability information, the first AI/ML related capability information is associated with the first device, the first AI/ML related capability information comprises M pieces of information, and M is a positive integer.

### CROSS-REFERENCE TO RELATED APPLICATIONS

This application is a continuation of International Application No. PCT/CN2022/127402, filed on Oct. 25, 2022, the disclosure of which is hereby incorporated by reference in its entirety.

### TECHNICAL FIELD

Embodiments of this application relate to the communications field, and more specifically, to a wireless communication method and device.

### RELATED ART

With continuous development of artificial intelligence (AI) and machine learning (ML) technologies, a combination of a communications technology and an AI/ML technology is one of future communication trends. However, an AI/ML feature is not considered in definition of capabilities in an existing communications system, and a capability for the AI/ML feature is required to be reorganized and defined.

### SUMMARY

Embodiments of this application provide a wireless communication method and device.

According to a first aspect, a communications device is provided, the communications device is a first device, the first device comprises a processor and a memory, the memory is configured to store a computer program, and the processor is configured to invoke the computer program stored from the memory and run the computer program, to cause the first device to perform following operation:
transmitting a first message to a second device.

The first message includes first AI/ML related capability information, the first AI/ML related capability information is associated with the first device, the first AI/ML related capability information includes M pieces of information, and M is a positive integer.

The M pieces of information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

According to a second aspect, a communications device is provided, the communications device is a second device, the second device comprises a processor and a memory, the memory is configured to store a computer program, and the processor is configured to invoke the computer program stored from the memory and run the computer program, to cause the second device to perform following operation:
receiving a first message transmitted by a first device.

The first message includes first AI/ML related capability information, the first AI/ML related capability information is associated with the first device, the first AI/ML related capability information includes M pieces of information, and M is a positive integer.

The M pieces of information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

In the foregoing technical solution, a first device may transmit first AI/ML related capability information to a second device, and M pieces of information included in the first AI/ML related capability information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

### BRIEF DESCRIPTION OF DRAWINGS

FIG. 1 is a schematic diagram of a communications system architecture to which an embodiment of this application is applied.

FIG. 2 is a schematic flowchart of a wireless communication method according to an embodiment of this application.

FIG. 3 is a schematic block diagram of a wireless communications device according to an embodiment of this application.

FIG. 4 is a schematic block diagram of a wireless communications device according to an embodiment of this application.

FIG. 5 is a schematic block diagram of a communications device according to an embodiment of this application.

FIG. 6 is a schematic block diagram of an apparatus according to an embodiment of this application.

FIG. 7 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by a person of ordinary skill in the art based on embodiments of this application without creative efforts shall fall within the protection scope of this application.

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), internet of things (IoT), wireless fidelity (WiFi), a fifth-generation (5G) system, a sixth-generation (6G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, sidelink (SL) communication, or vehicle-to-everything (V2X) communication. Embodiments of this application may also be applied to these communications systems.

In some embodiments, a communications system in embodiments of this application may be applied to a carrier aggregation (CA) scenario, a dual connectivity (DC) scenario, a standalone (SA) networking scenario, or a non-standalone (NSA) networking scenario.

In some embodiments, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

In some embodiments, a communications system in embodiments of this application may be applied to an FR1 frequency band (corresponding to a frequency band range 410 MHz to 7.125 GHZ), or may be applied to an FR2 frequency band (corresponding to a frequency band range 24.25 GHz to 52.6 GHZ), or may be applied to a new frequency band, for example, corresponding to a frequency band range 52.6 GHz to 71 GHZ, or a high frequency band corresponding to a frequency band range 71 GHz to 114.25 GHz.

Embodiments of this application are described with reference to a network device and a terminal device. The terminal device may also be referred to as a user equipment (UE), an access terminal, a subscriber unit, a subscriber station, a mobile site, a mobile station, a remote station, a remote terminal, a mobile device, a user terminal, a terminal, a wireless communications device, a user agent, a user apparatus, or the like.

The terminal device may be a station (ST) in a WLAN, or may be a cellular phone, a cordless phone, a session initiation protocol (SIP) phone, a wireless local loop (WLL) station, a personal digital assistant (PDA) device, a handheld device having a wireless communication function, a computing device or any other processing device connected to a wireless modem, a vehicle-mounted device, a wearable device, a terminal device in a next generation communications system such as an NR network or a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone, a tablet computer, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, a vehicle-mounted communications device, a wireless communications chip/application specific integrated circuit (ASIC)/system on chip (SoC), or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional Node B (eNB or eNodeB) in LTE, or a relay station or an access point, or a vehicle-mounted device, a wearable device, a network device or a gNB or a transmission reception point (TRP) in an NR network, or a network device in a future evolved PLMN, or a network device in an NTN, or the like.

By way of example rather than limitation, in embodiments of this application, the network device may have a mobility characteristic. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of small coverage and low transmit power, and are applicable to providing a high-rate data transmission service.

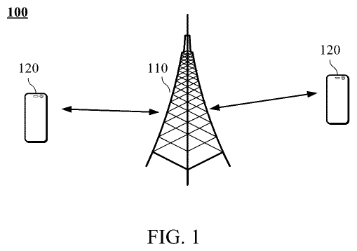

For example, a communications system 100 to which an embodiment of this application is applied is shown in FIG. 1. The communications system 100 may include a network device 110, and the network device 110 may be a device that communicates with a terminal device 120 (or referred to as a communications terminal or a terminal). The network device 110 may provide communication coverage in a specific geographic area, and may communicate with a terminal device located in the coverage.

FIG. 1 exemplarily shows one network device and two terminal devices. In some embodiments, the communications system 100 may include a plurality of network devices, and another quantity of terminal devices may be included in coverage of each network device, which is not limited in embodiments of this application.

In some embodiments, the communications system 100 may further include another network entity such as a network controller or a mobility management entity, which is not limited in embodiments of this application.

It should be understood that in embodiments of this application, a device having a communication function in a network or a system may be referred to as a communications device. The communications system 100 shown in FIG. 1 is used as an example. The communications device may include the network device 110 and the terminal device 120 that have a communication function. The network device 110 and the terminal device 120 may be specific devices described above, and details are not described herein again. The communications device may further include another device in the communications system 100, for example, another network entity such as a network controller or a mobility management entity, which is not limited in embodiments of this application.

It should be understood that the terms “system” and “network” may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that this specification relates to a terminal device and a network device, the terminal device may be, for example, a mobile phone, a machine facility, a customer premise equipment (CPE), an industrial device, a vehicle, or the like; and the network device may be an access network device (such as gNB), a core network device, or the like.

The terms used in implementations of this application are only used to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

It should be understood that, in embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In descriptions of embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may be, for example, evolution of an existing LTE protocol, an NR protocol, a Wi-Fi protocol, or a protocol related to another related communications system. A type of the protocol is not limited in this application.

To facilitate understanding of the technical solutions in embodiments of this application, the following describes the technical solutions in this application in detail by using specific embodiments. The following related technologies, as optional solutions, may be randomly combined with the technical solutions of embodiments of this application, all of which fall within the protection scope of embodiments of this application. Embodiments of this application include at least part of the following content.

To better understand embodiments of this application, a terminal capability related to this application is described.

A capability of a terminal device is generally used to indicate that a function that the terminal device can support and/or a function that the terminal device cannot support, and a network device may configure or activate a corresponding function for the terminal device according to the obtained terminal device capability.

To better understand embodiments of this application, a problem to be resolved in this application is described.

With continuous development of artificial intelligence (AI) and machine learning (ML) technologies, a combination of a communications technology and an AI/ML technology is one of future communication trends. However, an AI/ML feature is not considered in definition of capabilities in an existing communications system, and a capability for the AI/ML feature is required to be reorganized and defined.

Based on the foregoing problem, this application provides a solution for reporting AI/ML related capability information. AI/ML related capability information may be flexibly interacted between a first device and a second device, so that an AI/ML function is applied by a communications device in a refined manner.

The following describes the technical solutions in this application in detail by using specific embodiments.

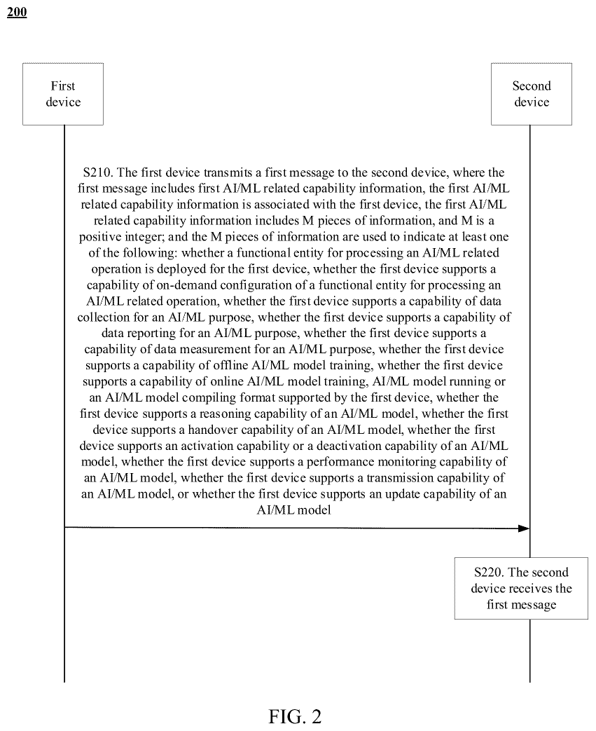

FIG. 2 is a schematic flowchart of a wireless communication method 200 according to an embodiment of this application. As shown in FIG. 2, the wireless communication method 200 may include at least part of the following content.

S210. A first device transmits a first message to a second device. The first message includes first AI/ML related capability information, the first AI/ML related capability information is associated with the first device, the first AI/ML related capability information includes M pieces of information, and M is a positive integer. The M pieces of information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

S220. The second device receives the first message.

In this embodiment of this application, AI/ML related capability information may be flexibly interacted between the first device and the second device, so that an AI/ML function is applied by a communications device in a refined manner.

In some embodiments, the first device is a terminal device, and the second device is a network device. The network device may be an access network device, or may be a core network device. That is, the terminal device may report AI/ML related capability information associated with the terminal device, so that the network device may deploy an AI/ML model or apply an AI/ML function based on the AI/ML related capability information associated with the terminal device.

In some embodiments, the first device is a network device, and the second device is a terminal device. The network device may be an access network device, or may be a core network device. That is, the network device may transmit AI/ML related capability information associated with the terminal device, so that the terminal device may deploy an AI/ML model or apply an AI/ML function based on the AI/ML related capability information associated with the network device.

In some embodiments, the first device is one terminal device, and the second device is another terminal device. That is, the one terminal device may transmit AI/ML related capability information associated with the terminal device, so that the another terminal device may deploy an AI/ML model or apply an AI/ML function based on the AI/ML related capability information.

In some embodiments, the first device is one network device, and the second device is another network device. For example, the first device is an access network device, and the second device is a core network device or another access network device. For another example, the first device is a core network device, and the second device is an access network device. For another example, the first device is one core network network element, and the second device is another core network network element. That is, the one network device may transmit AI/ML related capability information associated with the network device, so that the another network device may deploy an AI/ML model or apply an AI/ML function based on the AI/ML related capability information.

In some embodiments, the first message is one of the following: a non-access stratum (NAS) message, an access stratum (AS) message, an interface message, or an AI/ML dedicated message. In at least one embodiment, the AS message may be an RRC message, an L2 message, or an L1 message, and the interface message may be an NG message, an Xn message, an F1 message, or an E1 message.

In some embodiments, the M pieces of information include first information, and the first information is used to indicate whether a functional entity for processing an AI/ML related operation is deployed in the first device.

In some embodiments, the first information includes a first bit. The first bit is used to indicate whether a functional entity for processing an AI/ML related operation is deployed for the first device as a whole, and part of or all functional units in the first device share a capability indicated by the first bit. That is, AI/ML related operations related to functional units in the first device may be processed by using the functional entity for processing the AI/ML related operations.

In some embodiments, the first information is associated with an AI/ML functional entity type indication information, and the AI/ML functional entity type indication information is used to indicate a type of a functional entity for processing the AI/ML related operation. In at least one embodiment, the AI/ML functional entity type indication information associated with the first information is configured in a protocol default manner or is configured explicitly by using an additional information field included in the first information.

In some embodiments, the first information includes n₁ groups of sub-information, each group of sub-information in the n₁ groups of sub-information includes one or more bits, each group of the sub-information is associated with a functional unit or a group of functional units inside the first device, and n₁ is a positive integer.

In a case that each group of the sub-information includes one bit, an i^{th} group of sub-information is used to indicate whether a functional entity for processing an AI/ML related operation is deployed for a functional unit or a group of functional units, associated with the i^{th} group of sub-information, inside the first device.

Alternatively, in a case that each group of the sub-information includes at least two bits, each group of the sub-information includes a first information field and a second information field, a first information field included in an i^{th} group of sub-information is used to indicate whether a functional entity for processing an AI/ML related operation is deployed for a functional unit or a group of functional units, associated with the i^{th} group of sub-information, inside the first device, and a second information field included in the i^{th} group of sub-information is used to indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, each group of the sub-information includes a third information field, and a third information field included in an i^{th} group of sub-information is used to indicate whether a functional entity for processing an AI/ML related operation is deployed for a functional unit or a group of functional units, associated with the i^{th} group of sub-information, inside the first device, and indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and deployed in a functional unit or a group of functional units, associated with the i^{th} group of sub-information, inside the first device.

Herein i is a positive integer, and 1≤i≤n₁.

In some embodiments, the first information field includes one bit, and/or the second information field includes at least one bit.

In some embodiments, each group of the sub-information includes a fourth information field, and a fourth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₁ groups of sub-information, inside the first device is agreed upon by a protocol.

In some embodiments, the first information includes information about the type of the functional entity that is used for processing the AI/ML related operation and has been deployed in the first device. In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the first device; an AI/ML functional entity for processing an AI/ML related operation triggered by a functional unit other than a functional unit or a group of functional units, associated with an AI/ML functional entity, inside the first device; or an AI/ML functional entity capable of processing both an AI/ML related operation triggered by a functional unit or a group of functional units, associated with an AI/ML functional entity, inside the first device and an AI/ML related operation triggered by a functional unit other than a functional unit or a group of functional units, associated with an AI/ML functional entity, inside the first device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of following operation tasks: a data management task, a storage management task, a computing power management task, or a model management task. In at least one embodiment, the data management task includes but is not limited to at least one of the following: data collection, data storage, data modification, data update, data deletion, data replication, or data forwarding. In at least one embodiment, the storage management task includes but is not limited to at least one of the following: remaining storage size indication, storage reservation, storage allocation, storage sharing, storage recycling, or storage formatting. In at least one embodiment, the computing power management task includes but is not limited to at least one of the following: remaining computing power indication, computing power reservation, computing power allocation, computing power sharing, or computing power recycling. In at least one embodiment, the model management task includes but is not limited to at least one of the following: model training, model verification, model test, model deployment, model replication, model forwarding, model reasoning, model monitoring, model update, model activation, model deactivation, model deletion, or model handover.

Specifically, for example, the first information includes three bits, the first information includes three groups of sub-information, and each group of sub-information includes one bit. Each group of sub-information is associated with a functional unit or a group of functional units inside the first device, that is, each group of sub-information is used to indicate whether a functional entity for processing the AI/ML related operation is deployed for the functional unit or the group of functional units, associated with the group of sub-information, inside the first device. For example, a first group of sub-information of the first information (namely, a first bit of the first information) is associated with a physical layer (PHY) functional unit inside the first device, a second group of sub-information of the first information is associated with a medium access control (MAC) and radio link control (RLC) functional unit inside the first device, and a third group of sub-information of the first information is associated with a radio resource control (RRC) functional unit inside the first device.

Specifically, for another example, the first information includes nine bits, and the first information includes three groups of sub-information. Each group of sub-information includes three bits, and each correspondingly includes a first information field and a second information field. The first information field includes one bit, the second information field includes two bits, and the second information field may indicate at most four types of functional entities for processing the AI/ML related operation.

Specifically, for another example, the first information includes six bits, and the first information includes three groups of sub-information. Each group of sub-information includes two bits, each group of sub-information is associated with a functional unit or a group of functional units inside the first device, and each type of value for the respective group of sub-information corresponds to one type of AI/ML functional entity (herein there are four types of values ‘00’, ‘01’, ‘10’, and ‘11’ for two bits of the respective group of sub-information, and a case that a specific meaning is not defined for some values is allowed). The value ‘00’ indicates that a functional entity for processing the AI/ML related operation is not deployed for the functional unit or the group of functional units, associated with the group of sub-information, inside the first device, and the values ‘01’, ‘10’, and ‘11’ indicate that a functional entity for processing the AI/ML related operation is deployed for the functional unit or the group of functional units, associated with the group of sub-information, inside the first device, and each of ‘01’, ‘10’, and ‘11’ corresponds to a type of functional entity for processing the AI/ML related operation.

In some embodiments, the M pieces of information include second information, and the second information is used to indicate whether the first device supports the capability of on-demand configuration of a functional entity for processing an AI/ML related operation.

In some embodiments, the second information includes a second bit. The second bit is used to indicate whether the first device supports the capability of on-demand configuration of the functional entity for processing the AI/ML related operation, and part of or all functional units in the first device share a capability indicated by the second bit. That is, functional units in the first device shares this capability (certainly, a functional unit set that shares this capability may also be a subset of all functional unit sets supported in the first device), that is, the capability either indicates that all functional units in the first device support on-demand configuration of the functional entity for processing the AI/ML related operation, or indicates that all functional units in the first device do not support on-demand configuration of the functional entity for processing the AI/ML related operation.

In some embodiments, the second information is associated with type indication information of an AI/ML function entity capable of being configured on demand, where the type indication information of an AI/ML function entity capable of being configured on demand is used to indicate a type of the AI/ML function entity capable of being configured on demand. In at least one embodiment, AI/ML functional entity type indication information is configured in a protocol default manner or is configured explicitly by using an additional information field included in the second information.

In some embodiments, the second information includes n₂ groups of sub-information, each group of sub-information in the n₂ groups of sub-information includes one or more bits, each group of the sub-information is associated with a functional unit or a group of functional units inside the first device, and n₂ is a positive integer.

In a case that each group of the sub-information includes one bit, an i^{th} group of sub-information is used to indicate whether a functional unit or a group of functional units, associated with the i^{th} group of sub-information, inside the first device supports a capability of on-demand configuration of a functional entity for processing an AI/ML related operation.

Alternatively, in a case that each group of the sub-information includes at least two bits, each group of the sub-information includes a fifth information field and a sixth information field. A fifth information field included in an i^{th} group of sub-information is used to indicate whether a functional unit or a group of functional units, associated with the i^{th} group of sub-information, inside the first device supports a capability of on-demand configuration of a functional entity for processing an AI/ML related operation. A sixth information field included in the i^{th} group of sub-information is used to indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, each group of the sub-information includes a seventh information field. A seventh information field included in an i^{th} group of sub-information is used to indicate whether a functional unit or a group of functional units, associated with the i^{th} group of sub-information, inside the first device supports a capability of on-demand configuration of a functional entity for processing an AI/ML related operation, and indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and configured on demand in a functional unit or a group of functional units, associated with the i^{th} group of sub-information, inside the first device.

Herein i is a positive integer, and 1≤i≤n₂.

In some embodiments, the fifth information field includes one bit, and/or the sixth information field includes at least one bit.

In some embodiments, each bit of the sixth information field is associated with a type of or a group of types of AI/ML functional entities, and the value of each bit included in the sixth information field is used to determine whether the type of or the group of types of AI/ML functional entities associated with the value of respective bit supports on-demand configuration; or each type of bit status value of the sixth information field is associated with a type of or a group of types of AI/ML functional entities, and each type of bit status value of the sixth information field indicates that the type of or the group of types of AI/ML function entities associated with the respective type of bit status value supports on-demand configuration.

In some embodiments, the type of or the group of types of AI/ML function entities associated with respective bit of the sixth information field is agreed upon by a protocol, or the type of or the group of types of AI/ML function entities associated with respective type of bit status value of the sixth information field is agreed upon by a protocol.

In some embodiments, each group of the sub-information includes an eighth information field, and an eighth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₂ groups of sub-information, inside the first device is agreed upon by a protocol.

In some embodiments, the second information includes information about the type of the functional entity used for processing the AI/ML related operation and supported by the first device.

Specifically, for example, the second information includes three bits, and the second information includes three groups of sub-information. Each group of sub-information includes one bit, and each group of sub-information is associated with a functional unit or a group of functional units inside the first device, that is, each group of sub-information is used to indicate whether the functional unit or the group of functional units, associated with the group of sub-information, inside the first device supports the capability of on-demand configuration of a functional entity for processing an AI/ML related operation. For example, a first group of sub-information of the second information (namely, a first bit of the second information) is associated with a PHY functional unit inside the first device, a second group of sub-information of the second information (namely, a second bit of the second information) is associated with a MAC and RLC functional unit in the first device, and a third group of sub-information of the second information (namely, a third bit of the second information) is associated with an RRC functional unit in the first device.

Specifically, for another example, the second information includes nine bits, and the second information includes three groups of sub-information. Each group of sub-information includes three bits and correspondingly includes a fifth information field and a sixth information field. The fifth information field includes one bit, the sixth information field includes two bits, and each bit of the sixth information field is associated with a type of or a group of types of AI/ML function entities. For example, a value ‘01’ of the sixth information field indicates that a type of or a group of types of AI/ML functional entities associated with a first bit of the sixth information field does not support on-demand configuration, and a type of or a group of types of AI/ML functional entities associated with a second bit of the sixth information field supports on-demand configuration.

Specifically, for another example, the second information includes nine bits, and the second information includes three groups of sub-information. Each group of sub-information includes three bits and correspondingly includes a fifth information field and a sixth information field. The fifth information field includes one bit, the sixth information field includes two bits, and the sixth information field has four types of values. Each type of value is associated with a type of or a group of types of AI/ML functional entities. For example, a value ‘01’ of the sixth information field indicates that a type of or a group of types of AI/ML functional entities associated with the value ‘01’ supports on-demand configuration.

Specifically, for another example, the second information includes six bits, and the second information includes three groups of sub-information. Each group of sub-information includes two bits, each group of sub-information is associated with a functional unit or a group of functional units inside the first device, and each type of value for the respective group of sub-information corresponds to one type of AI/ML functional entity (herein there are four types of values ‘00’, ‘01’, ‘10’, and ‘11’ for two bits of the respective group of sub-information, and a case that a specific meaning is not defined for some values is allowed). The value ‘00’ indicates that a functional unit or a group of functional units, associated with the group of sub-information, inside the first device does not support a functional entity used for processing the AI/ML related operation and configured on demand. The values ‘01’, ‘10’, and ‘11’ indicate that a functional unit or a group of functional units, associated with the group of sub-information, inside the first device supports a functional entity used for processing the AI/ML related operation and configured on demand, and each of ‘01’, ‘10’, and ‘11’ corresponds to a type of or a group of types of functional entity for processing the AI/ML related operation.

In some embodiments, the second information is associated with configuration mode information, and the configuration mode information is used to indicate a mode of triggering establishment of an AI/ML functional entity configured on demand.

In some embodiments, the mode of triggering establishment of the AI/ML functional entity configured on demand includes at least one of the following: the first device autonomously triggering establishment of the AI/ML functional entity configured on demand, the second device actively requesting the first device to establish the AI/ML functional entity configured on demand, or the first device establishing the AI/ML functional entity configured on demand after the first device initiates an establishment request and obtains an acknowledgement from the second device.

In some embodiments, the configuration mode information associated with the second information is agreed upon by a protocol. For example, the protocol directly agrees that the meaning of the configuration mode information associated with the second information is that an AI/ML functional entity configured on demand is established based on triggering of the second device, that is, all AI/ML functional entities configured on demand and determined by the second information can be established on the first device side only in a manner of triggering of the second device.

In some embodiments, the second information includes a ninth information field, and the ninth information field is used to indicate the configuration mode information associated with the second information.

In some embodiments, in a case that the ninth information field is used to indicate the configuration mode information associated with the second information, an indication granularity of the ninth information field includes one of the following: a granularity based on the first device, a granularity based on a sub-information group included in the second information, and a granularity based on a type of the AI/ML functional entity configured on demand.

In some embodiments, in a case that the indication granularity of the ninth information field is the granularity based on the first device, configuration modes corresponding to all AI/ML function entities configured on demand and supported by the first device are the same. That is, configuration modes corresponding to all the AI/ML functional entities configured on demand and supported by the first device are the same. A specific configuration mode is provided by using common configuration mode information.

In some embodiments, in a case that the indication granularity of the ninth information field is the granularity based on a sub-information group included in the second information, configuration modes corresponding to all AI/ML function entities configured on demand and supported by respective sub-information group included in the second information are the same. That is, the configuration is performed according to a granularity of a sub-information group of the second information (each group of sub-information is associated with a functional unit or a group of functional units inside the first device, or may be configured according to a granularity of a functional unit inside the first device). In this manner, regardless of whether one or more types of AI/ML functional entities are configured on demand and correspondingly supported by a group of sub-information of the second information, configuration modes corresponding to all AI/ML functional entities configured on demand and supported by the group of sub-information are the same. A specific configuration mode is provided by using configuration mode information associated with a sub-information group.

In some embodiments, in a case that the indication granularity of the ninth information field is the granularity based on a type of the AI/ML functional entity configured on demand, each type of the AI/ML functional entity configured on demand and supported by the second information is independently associated with configuration mode information used to indicate a configuration mode supported by the type of the AI/ML functional entity. That is, each type of the AI/ML functional entity configured on demand and supported by the second information is independently associated with one piece of configuration mode information, which is used to indicate a configuration mode supported by the type of the AI/ML functional entity.

In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the first device; an AI/ML functional entity for processing an AI/ML related operation triggered by a functional unit other than a functional unit or a group of functional units, associated with an AI/ML functional entity, inside the first device; or an AI/ML functional entity capable of processing both an AI/ML related operation triggered by a functional unit or a group of functional units, associated with an AI/ML functional entity, inside the first device and an AI/ML related operation triggered by a functional unit other than a functional unit or a group of functional units, associated with an AI/ML functional entity, inside the first device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of the following operation tasks: a data management task, a storage management task, a computing power management task, or a model management task. In at least one embodiment, the data management task includes but is not limited to at least one of the following: data collection, data storage, data modification, data update, data deletion, data replication, or data forwarding. In at least one embodiment, the storage management task includes but is not limited to at least one of the following: remaining storage size indication, storage reservation, storage allocation, storage sharing, storage recycling, or storage formatting. In at least one embodiment, the computing power management task includes but is not limited to at least one of the following: remaining computing power indication, computing power reservation, computing power allocation, computing power sharing, or computing power recycling. In at least one embodiment, the model management task includes but is not limited to at least one of the following: model training, model verification, model test, model deployment, model replication, model forwarding, model reasoning, model monitoring, model update, model activation, model deactivation, model deletion, or model handover.

In some embodiments, the M pieces of information include third information, and the third information is used to indicate whether the first device supports the capability of data collection for the AI/ML purpose.

In some embodiments, the third information includes a third bit. The third bit is used to indicate whether the first device as a whole supports the capability of data collection for the AI/ML purpose. That is, the third information includes one bit, which is used to indicate whether the first device as a whole supports the capability of data collection for the AI/ML purpose, and types of collected data is not required to be identified.

In some embodiments, the third information is associated with a type of collected data.

In some embodiments, the type of collected data associated with the third information is agreed upon by a protocol, or the type of collected data associated with the third information is indicated by an information field included in the third information.

In some embodiments, the third information includes n₃ groups of sub-information, each group of sub-information in the n₃ groups of sub-information includes one or more bits, each group of the sub-information is associated with a functional unit or a group of functional units inside the first device, and n₃ is a positive integer.

In a case that each group of the sub-information includes one bit, an i^{th} group of sub-information is used to indicate whether a functional unit or a group of functional units, associated with the i^{th} group of sub-information, inside the first device supports the capability of data collection for the AI/ML purpose.

Alternatively, in a case that each group of the sub-information includes at least two bits, each group of the sub-information includes a tenth information field and an eleventh information field. A tenth information field included in an i^{th} group of sub-information is used to indicate whether a functional unit or a group of functional units, associated with the i^{th} group of sub-information, inside the first device supports the capability of data collection for the AI/ML purpose, and an eleventh information field included in the i^{th} group of sub-information is used to indicate a set of types of collected data.

Alternatively, in a case that each group of the sub-information includes at least one bit, each group of the sub-information includes a twelfth information field. A twelfth information field included in an i^{th} group of sub-information is used to indicate whether a functional unit or a group of functional units, associated with the i^{th} group of sub-information, inside the first device supports the capability of data collection for the AI/ML purpose, and indicate a set of types of collected data.

Alternatively, in a case that each group of the sub-information includes at least one bit, an i^{th} group of sub-information is used to indicate a set of types of data collected by a functional unit or a group of functional units, associated with the i^{th} group of sub-information, inside the first device.

Herein i is a positive integer, and 1≤i≤n₃.

Specifically, for example, the third information includes six bits, and the third information includes three groups of sub-information. Each group of sub-information includes two bits, each group of sub-information is associated with a functional unit or a group of functional units inside the first device, and each type of value for the respective group of sub-information corresponds to one set of types of collected data (herein there are four types of values ‘00’, ‘01’, ‘10’, and ‘11’ for two bits of the respective group of sub-information, and a case that a specific meaning is not defined for some values is allowed). The value ‘00’ indicates that a functional unit or a group of functional units, associated with the group of sub-information, inside the first device does not support the capability of data collection for the AI/ML purpose. The values ‘01’, ‘10’, and ‘11’ indicate that a functional unit or a group of functional units, associated with the group of sub-information, inside the first device supports the capability of data collection for the AI/ML purpose, and each of ‘01’, ‘10’, and ‘11’ corresponds to a type of or a group of types of collected data.

In some embodiments, the tenth information field includes one bit, and/or the eleventh information field includes at least one bit.

In some embodiments, each bit of the eleventh information field is associated with a type of or a group of types of collected data, and the value of each bit included in the eleventh information field is used to determine whether the type of or the group of types of collected data associated with the value of respective bit supports being collected by the first device; or each type of bit status value of the eleventh information field is associated with a type of or a group of types of collected data, and each type of bit status value of the eleventh information field indicates that the type of or the group of types of collected data associated with respective type of bit status value supports being collected by the first device.

In some embodiments, the type of or the group of types of collected data associated with respective bit of the eleventh information field is agreed upon by a protocol, or the type of or the group of types of collected data associated with respective type of bit status value of the eleventh information field is agreed upon by a protocol.

In some embodiments, each group of the sub-information includes a thirteenth information field, and a thirteenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₃ groups of sub-information, inside the first device is agreed upon by a protocol.

In some embodiments, the third information includes type information of at least a type of or a group of types of collected data supported by the first device. In some embodiments, the third information is associated with data collection trigger type indication information.

A bit status value of the data collection trigger type indication information is used to indicate that the first device supports only data collection triggered by the first device, or a bit status value of the data collection trigger type indication information is used to indicate that the first device supports only data collection triggered by the second device, or a bit status value of the data collection trigger type indication information is used to indicate that the first device supports both data collection triggered by the first device and data collection triggered by the second device.

In some embodiments, the data collection trigger type indication information associated with the third information is agreed upon by a protocol, or the data collection trigger type indication information associated with the third information is indicated by an information field in the third information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the M pieces of information include fourth information, and the fourth information is used to indicate whether the first device supports the capability of data reporting for the AI/ML purpose.

In some embodiments, the fourth information includes a fourth bit. The fourth bit is used to indicate whether the first device as a whole supports the capability of data reporting for the AI/ML purpose. That is, the fourth information includes one bit, which is used to indicate whether the first device as a whole supports the capability of data reporting for the AI/ML purpose, and types of reported data are not required to be identified.

In some embodiments, the fourth information is associated with a type of reported data.

In some embodiments, the type of reported data associated with the fourth information is agreed upon by a protocol, or the type of reported data associated with the fourth information is indicated by an information field included in the fourth information.

In some embodiments, the fourth information includes n₄ groups of sub-information, and each group of sub-information in the n₄ groups of sub-information includes one or more bits. Each group of the sub-information is associated with a functional unit or a group of functional units inside the first device, and n₄ is a positive integer.

In a case that each group of the sub-information includes one bit, an i^{th} group of sub-information is used to indicate whether a functional unit or a group of functional units, associated with the i^{th} group of sub-information, inside the first device supports the capability of data reporting for the AI/ML purpose.

Alternatively, in a case that each group of the sub-information includes at least two bits, each group of the sub-information includes a fourteenth information field and a fifteenth information field. A fourteenth information field included in an i^{th} group of sub-information is used to indicate whether a functional unit or a group of functional units, associated with the i^{th} group of sub-information, inside the first device supports the capability of data reporting for the AI/ML purpose, and a fifteenth information field included in the i^{th} group of sub-information is used to indicate a set of types of reported data.

Alternatively, in a case that each group of the sub-information includes at least one bit, each group of the sub-information includes a sixteenth information field. A sixteenth information field included in an i^{th} group of sub-information is used to indicate whether a functional unit or a group of functional units, associated with the i^{th} group of sub-information, inside the first device supports the capability of data reporting for the AI/ML purpose, and indicate a set of types of reported data.

Alternatively, in a case that each group of the sub-information includes at least one bit, an i^{th} group of sub-information is used to indicate a set of types of data reported by a functional unit or a group of functional units, associated with the i^{th} group of sub-information, inside the first device.

Herein i is a positive integer, and 1≤i≤n₄.

Specifically, for example, the fourth information includes six bits, and the fourth information includes three groups of sub-information. Each group of sub-information includes two bits, each group of sub-information is associated with a functional unit or a group of functional units inside the first device, and each type of value for the respective group of sub-information corresponds to one set of types of reported data (herein there are four types of values ‘00’, ‘01’, ‘10’, and ‘11’ for two bits of the respective group of sub-information, and a case that a specific meaning is not defined for some values is allowed). The value ‘00’ indicates that a functional unit or a group of functional units, associated with the group of sub-information, inside the first device does not support the capability of data reporting for the AI/ML purpose. The values ‘01’, ‘10’, and ‘11’ indicate that a functional unit or a group of functional units, associated with the group of sub-information, inside the first device supports the capability of data reporting for the AI/ML purpose, and each of ‘01’, ‘10’, and ‘11’ corresponds to a type of or a group of types of reported data.

In some embodiments, the fourteenth information field includes one bit, and/or the fifteenth information field includes at least one bit.

In some embodiments, each bit of the fifteenth information field is associated with a type of or a group of types of reported data, and the value of each bit included in the fifteenth information field is used to determine whether the type of or the group of types of reported data associated with the value of respective bit supports being reported by the first device; or each type of bit status value of the fifteenth information field is associated with a type of or a group of types of reported data, and each type of bit status value of the fifteenth information field indicates that the type of or the group of types of reported data associated with respective type of bit status value supports being reported by the first device.

In some embodiments, the type of or the group of types of reported data associated with respective bit of the fifteenth information field is agreed upon by a protocol, or the type of or the group of types of reported data associated with respective type of bit status value of the fifteenth information field is agreed upon by a protocol.

In some embodiments, each group of the sub-information includes a seventeenth information field, and a seventeenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₄ groups of sub-information, inside the first device is agreed upon by a protocol.

In some embodiments, the fourth information includes type information of at least a type of or a group of types of reported data supported by the first device.

In some embodiments, the fourth information is associated with a data reporting trigger type indication information.

A bit status value of the data reporting trigger type indication information is used to indicate that the first device supports only data reporting triggered by the first device, or a bit status value of the data reporting trigger type indication information is used to indicate that the first device supports only data reporting triggered by the second device, or a bit status value of the data reporting trigger type indication information is used to indicate that the first device supports both data reporting triggered by the first device and data reporting triggered by the second device.

In some embodiments, the data reporting trigger type indication information associated with the fourth information is agreed upon by a protocol, or the data reporting trigger type indication information associated with the fourth information is indicated by an information field in the fourth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the M pieces of information include fifth information, and the fifth information is used to indicate whether the first device supports the capability of data measurement for the AI/ML purpose.

In some embodiments, the fifth information includes a fifth bit. The fifth bit is used to indicate whether the first device as a whole supports the capability of data measurement for the AI/ML purpose.

In some embodiments, the fifth information is associated with a type of measured data.

In some embodiments, the type of measured data associated with the fifth information is agreed upon by a protocol, or the type of measured data associated with the fifth information is indicated by an information field included in the fifth information.

In some embodiments, the fifth information includes n₅ groups of sub-information, and each group of sub-information in the n₅ groups of sub-information includes one or more bits. Each group of the sub-information is associated with a functional unit or a group of functional units inside the first device, and n₅ is a positive integer.

In a case that each group of the sub-information includes one bit, an i^{th} group of sub-information is used to indicate whether a functional unit or a group of functional units, associated with the i^{th} group of sub-information, inside the first device supports the capability of data measurement for the AI/ML purpose.

Alternatively, in a case that each group of the sub-information includes at least two bits, each group of the sub-information includes an eighteenth information field and a nineteenth information field. An eighteenth information field included in an i^{th} group of sub-information is used to indicate whether a functional unit or a group of functional units, associated with the i^{th} group of sub-information, inside the first device supports the capability of data measurement for the AI/ML purpose, and a nineteenth information field included in the i^{th} group of sub-information is used to indicate a set of types of measured data.

Alternatively, in a case that each group of the sub-information includes at least one bit, each group of the sub-information includes a twentieth information field. A twentieth information field included in an i^{th} group of sub-information is used to indicate whether a functional unit or a group of functional units, associated with the i^{th} group of sub-information, inside the first device supports the capability of data measurement for the AI/ML purpose, and indicate a set of types of measured data.

Alternatively, in a case that each group of the sub-information includes at least one bit, an i^{th} group of sub-information is used to indicate a set of types of data measured by a functional unit or a group of functional units, associated with the i^{th} group of sub-information, inside the first device.

Herein i is a positive integer, and 1≤i≤n₅.

In some embodiments, the eighteenth information field includes one bit, and/or the nineteenth information field includes at least one bit.

In some embodiments, each bit of the nineteenth information field is associated with a type of or a group of types of measured data, and the value of each bit included in the nineteenth information field is used to determine whether the type of or the group of types of measured data associated with the value of respective bit supports being measured by the first device; or each type of bit status value of the nineteenth information field is associated with a type of or a group of types of measured data, and each type of bit status value of the nineteenth information field indicates that the type of or the group of types of measured data associated with respective type of bit status value supports being measured by the first device.

In some embodiments, the type of or the group of types of measured data associated with respective bit of the nineteenth information field is agreed upon by a protocol, or the type of or the group of types of measured data associated with respective type of bit status value of the nineteenth information field is agreed upon by a protocol.

In some embodiments, each group of the sub-information includes a twenty-first information field, and a twenty-first information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₅ groups of sub-information, inside the first device is agreed upon by a protocol.

In some embodiments, the fifth information includes type information of at least a type of or a group of types of measured data supported by the first device.

In some embodiments, the fifth information is associated with data measurement trigger type indication information.

A bit status value of the data measurement trigger type indication information is used to indicate that the first device supports only data measurement triggered by the first device, or a bit status value of the data measurement trigger type indication information is used to indicate that the first device supports only data measurement triggered by the second device, or a bit status value of the data measurement trigger type indication information is used to indicate that the first device supports both data measurement triggered by the first device and data measurement triggered by the second device.

In some embodiments, the data measurement trigger type indication information associated with the fifth information is agreed upon by a protocol, or the data measurement trigger type indication information associated with the fifth information is indicated by an information field in the fifth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, capabilities in the third information, the fourth information, and the fifth information may be further subdivided into at least one of a data processing capability, a data storage capability, or a data calculation capability.

In some embodiments, the capabilities in the third information, the fourth information, and the fifth information are allowed to be combined into one type of capability for reporting. The first device either supports all capabilities or no capability. In at least one embodiment, the combined capability may be associated with data type information capable of being processed. The combined capability may alternatively be reported according to at least one of the following granularities: a granularity based on a functional unit, a granularity based on an identity of an AI/ML model, or a granularity based on a type of processed data.

In some embodiments, the M pieces of information include sixth information, and the sixth information is used to indicate whether the first device supports the capability of offline AI/ML model training.

In some embodiments, the sixth information is associated with offline AI/ML model training type indication information.

A bit status value of the offline AI/ML model training type indication information is used to indicate that the first device supports only offline AI/ML model training triggered by the first device, or a bit status value of the offline AI/ML model training type indication information is used to indicate that the first device supports only offline AI/ML model training triggered by the second device, or a bit status value of the offline AI/ML model training type indication information is used to indicate that the first device supports both offline AI/ML model training triggered by the first device and offline AI/ML model training triggered by the second device.

In some embodiments, the offline AI/ML model training type indication information associated with the sixth information is agreed upon by a protocol, or the offline AI/ML model training type indication information associated with the sixth information is indicated by an information field in the sixth information.

In some embodiments, the M pieces of information include seventh information, and the seventh information is used to indicate whether the first device supports the capability of online AI/ML model training.

In some embodiments, the seventh information is associated with an online AI/ML model training type indication information.

A bit status value of the online AI/ML model training type indication information is used to indicate that the first device supports only online AI/ML model training triggered by the first device, or a bit status value of the online AI/ML model training type indication information is used to indicate that the first device supports only online AI/ML model training triggered by the second device, or a bit status value of the online AI/ML model training type indication information is used to indicate that the first device supports both online AI/ML model training triggered by the first device and online AI/ML model training triggered by the second device.

In some embodiments, the online AI/ML model training type indication information associated with the seventh information is agreed upon by a protocol, or the online AI/ML model training type indication information associated with the seventh information is indicated by an information field in the seventh information.

In some embodiments, capabilities in the sixth information and the seventh information are allowed to be combined into one type of capability for reporting. The first device supports either all capabilities or no capability. In at least one embodiment, the combined capability may alternatively be associated with training type indication information. The combined capability may alternatively be reported according to at least one of the following granularities: a granularity based on a functional unit, a granularity based on an identity of an AI/ML model, or a granularity based on a type of associated training.

In some embodiments, the M pieces of information include eighth information. The eighth information is used to indicate the AI/ML model running or the AI/ML model compiling format supported by the first device. There may be differences in operating or compilation environments supported by different first devices. Reporting the capability helps the second device to transmit, for the first device, an AI/ML model suitable for a configuration environment of the first device.

In some embodiments, the M pieces of information include ninth information, and the ninth information is used to indicate whether the first device supports the reasoning capability of the AI/ML model.

In some embodiments, the ninth information is associated with AI/ML model reasoning type indication information.

A bit status value of the AI/ML model reasoning type indication information is used to indicate that the first device supports only non-federated reasoning or centralized reasoning, or a bit status value of the AI/ML model reasoning type indication information is used to indicate that the first device supports only federated reasoning or distributed reasoning, or a bit status value of the AI/ML model reasoning type indication information is used to indicate that the first device supports federated reasoning and non-federated reasoning.

In some embodiments, the AI/ML model reasoning type indication information associated with the ninth information is agreed upon by a protocol, or the AI/ML model reasoning type indication information associated with the ninth information is indicated by an information field in the ninth information.

In some embodiments, the M pieces of information include tenth information, and the tenth information is used to indicate whether the first device supports the handover capability of the AI/ML model.

In some embodiments, the tenth information is associated with an AI/ML model handover type indication information.

A bit status value of the AI/ML model handover type indication information is used to indicate that the AI/ML model is allowed to be handed over only by the first device, or a bit status value of the AI/ML model handover type indication information is used to indicate that the AI/ML model is allowed to be handed over only by the second device, or a bit status value of the AI/ML model handover type indication information is used to indicate that the AI/ML model is allowed to be handed over by the first device or the second device.

In some embodiments, the AI/ML model handover type indication information associated with the tenth information is agreed upon by a protocol, or the AI/ML model handover type indication information associated with the tenth information is indicated by an information field in the tenth information.

In some embodiments, the M pieces of information include eleventh information, and the eleventh information is used to indicate whether the first device supports the activation capability or the deactivation capability of the AI/ML model.

In some embodiments, the eleventh information is associated with AI/ML model activation/deactivation type indication information.

A bit status value of the AI/ML model activation/deactivation type indication information is used to indicate that the AI/ML model is allowed to be activated or deactivated only by the first device, or a bit status value of the AI/ML model activation/deactivation type indication information is used to indicate that the AI/ML model is allowed to be activated or deactivated only by the second device, or a bit status value of the AI/ML model activation/deactivation type indication information is used to indicate that the AI/ML model is allowed to be activated or deactivated by the first device or the second device.

In some embodiments, the AI/ML model activation/deactivation type indication information associated with the eleventh information is agreed upon by a protocol, or the AI/ML model activation/deactivation type indication information associated with the eleventh information is indicated by an information field in the eleventh information.

In some embodiments, the M pieces of information include twelfth information, and the twelfth information is used to indicate whether the first device supports the performance monitoring capability of the AI/ML model.

In some embodiments, the twelfth information is associated with AI/ML model performance monitoring type indication information.

A bit status value of the AI/ML model performance monitoring type indication information is used to indicate that performance monitoring of the AI/ML model is allowed to be performed only by the first device, or a bit status value of the AI/ML model performance monitoring type indication information is used to indicate that performance monitoring of the AI/ML model is allowed to be performed only by the second device, or a bit status value of the AI/ML model performance monitoring type indication information is used to indicate that performance monitoring of the AI/ML model is allowed to be performed by the first device or the second device.

In some embodiments, the AI/ML model performance monitoring type indication information associated with the twelfth information is agreed upon by a protocol, or the AI/ML model performance monitoring type indication information associated with the twelfth information is indicated by an information field in the twelfth information.

In some embodiments, the M pieces of information include thirteenth information, and the thirteenth information is used to indicate whether the first device supports the transmission capability of the AI/ML model.

In some embodiments, the thirteenth information is associated with an AI/ML model transmission type indication information.

A bit status value of the AI/ML model transmission type indication information is used to indicate that the first device supports only downloading of the AI/ML model, or a bit status value of the AI/ML model transmission type indication information is used to indicate that the first device supports only uploading of the AI/ML model, or a bit status value of the AI/ML model transmission type indication information is used to indicate that the first device supports both downloading of the AI/ML model and uploading of the AI/ML model.

In some embodiments, the AI/ML model transmission type indication information associated with the thirteenth information is agreed upon by a protocol, or the AI/ML model transmission type indication information associated with the thirteenth information is indicated by an information field in the thirteenth information.

In some embodiments, the transmission capability of the AI/ML model includes a data transmission format of the AI/ML model, and the data transmission format of the AI/ML model is used to indicate an AI/ML model transmission format supported by the first device. Certainly, the transmission capability of the AI/ML model may further include another AI/ML model transmission information, which is not limited in embodiments of this application.

In some embodiments, the M pieces of information include fourteenth information, and the fourteenth information is used to indicate whether the first device supports the update capability of the AI/ML model.

In some embodiments, the fourteenth information is associated with AI/ML model update type indication information.

A bit status value of the AI/ML model update type indication information is used to indicate that the AI/ML model is allowed to be updated only by the first device, or a bit status value of the AI/ML model update type indication information is used to indicate that the AI/ML model is allowed to be updated only by the second device, or a bit status value of the AI/ML model update type indication information is used to indicate that the AI/ML model is allowed to be updated by the first device or the second device.

In some embodiments, the AI/ML model update type indication information associated with the fourteenth information is agreed upon by a protocol, or the AI/ML model update type indication information associated with the fourteenth information is indicated by an information field in the fourteenth information.

In some embodiments, a reporting granularity for part of or all of the M pieces of information includes at least one of following: a granularity based on the first device (functional units inside the first device are not identified), a granularity based on a functional unit included in the first device, or a granularity based on an identity of the AI/ML model. A compound granularity reporting capability is allowed, for example, reporting according to a granularity based on an AI/ML model identity and a granularity based on a functional unit included in the first device.

In some embodiments, the first message further includes at least one AI/ML model identity information, and there is a one-to-one mapping relationship or many-to-one mapping relationship between the AI/ML model identity information and capabilities corresponding to the first information to the fourteenth information.

The one-to-one mapping relationship means that an AI/ML model identity is associated with at least one of the capabilities corresponding to the first information to the fourteenth information.

The many-to-one mapping relationship means that a plurality of AI/ML model identities are associated with at least one of the capabilities corresponding to the first information to the fourteenth information.

In some embodiments, it is allowed that part of capability information included in the first message is reported according to one granularity, and the other part of capability information included in the first message is reported according to another granularity, which is not limited in this application.

In some embodiments, the M pieces of information indicate identity information of M capability sets.

At least part of different content of capability information is included in different capability sets in the M capability sets, or at least part of different types of capability information is included in different capability sets in the M capability sets.

A type of capability information included in j^{th} capability set of the M capability sets includes at least one of following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

Herein j is a positive integer, and 1≤j≤M.

In some embodiments, a type of capability information included in respective capability set in the M capability sets is agreed upon by a protocol, or a type of capability information included in respective capability set in the M capability sets is indicated or configured by a network device.

That is, in the embodiments, capability reporting may be performed based on a capability template agreed upon by a protocol. The protocol directly specifies one or more capability sets. A capability information type included in respective capability set is provided in a protocol default manner. Each capability set is associated with one identity (ID), and different content of capability information is included in different capability sets. The first device may implement capability information reporting by reporting, to the second device, supported identity (ID) information associated with a capability set.

In some embodiments, the transmission capability of the AI/ML model includes a data transmission format of the AI/ML model. Certainly, the transmission capability of the AI/ML model may further include another AI/ML model transmission information, which is not limited in embodiments of this application.

In some embodiments, the first device receives a second message transmitted by the second device.

The second message includes second AI/ML related capability information, the second AI/ML related capability information is associated with the second device, the second AI/ML related capability information includes S pieces of information, and S is a positive integer.

The S pieces of information are used to indicate at least one of following: whether a functional entity for processing an AI/ML related operation is deployed for the second device, whether the second device supports a capability of on-demand configuration of a functional entity for processing an AI/ML related operation, whether the second device supports a capability of data collection for an AI/ML purpose, whether the second device supports a capability of data reporting for an AI/ML purpose, whether the second device supports a capability of data measurement for an AI/ML purpose, whether the second device supports a capability of offline AI/ML model training, whether the second device supports a capability of online AI/ML model training, AI/ML model running or an AI/ML model compiling format supported by the second device, whether the second device supports a reasoning capability of an AI/ML model, whether the second device supports a handover capability of an AI/ML model, whether the second device supports an activation capability or a deactivation capability of an AI/ML model, whether the second device supports a performance monitoring capability of an AI/ML model, whether the second device supports a transmission capability of an AI/ML model, or whether the second device supports an update capability of an AI/ML model.

In some embodiments, a reporting granularity for part of or all of the S pieces of information includes at least one of following: a granularity based on the second device, a granularity based on a functional unit included in the second device, or a granularity based on an identity of the AI/ML model. A compound granularity reporting capability is allowed, for example, reporting according to a granularity based on an AI/ML model identity and a granularity based on a functional unit included in the second device.

In some embodiments, the second message further includes at least one AI/ML model identity information, and there is a one-to-one mapping relationship or many-to-one mapping relationship between the AI/ML model identity information and capabilities corresponding to the following fifteenth information to the twenty-eighth information.

The one-to-one mapping relationship means that an AI/ML model identity is associated with at least one of the capabilities corresponding to the following fifteenth information to the twenty-eighth information.

The many-to-one mapping relationship means that a plurality of AI/ML model identities are associated with at least one of the capabilities corresponding to the following fifteenth information to the twenty-eighth information.

In some embodiments, it is allowed that part of capability information included in the second message is reported according to one granularity, and the other part of capability information included in the second message is reported according to another granularity, which is not limited in this application.

In some embodiments, the transmission capability of the AI/ML model includes a data transmission format of the AI/ML model. Certainly, the transmission capability of the AI/ML model may further include another AI/ML model transmission information, which is not limited in embodiments of this application.

In some embodiments, the second message is one of following: a NAS message, an AS message, an interface message, or an AI/ML dedicated message. In at least one embodiment, the AS message may be an RRC message, an L2 message, or an L1 message, and the interface message may be an NG message, an Xn message, an F1 message, or an E1 message.

In some embodiments, the second message is a response message of the first message or a message actively triggered by the second device.

In some embodiments, the S pieces of information indicate identity information of S capability sets.

At least part of different content of capability information is included in different capability sets in the S capability sets, or at least part of different types of capability information is included in different capability sets in the S capability sets.

A type of capability information included in j^{th} capability set of the S capability sets includes at least one of following: whether a functional entity for processing an AI/ML related operation is deployed for the second device, whether the second device supports a capability of on-demand configuration of a functional entity for processing an AI/ML related operation, whether the second device supports a capability of data collection for an AI/ML purpose, whether the second device supports a capability of data reporting for an AI/ML purpose, whether the second device supports a capability of data measurement for an AI/ML purpose, whether the second device supports a capability of offline AI/ML model training, whether the second device supports a capability of online AI/ML model training, AI/ML model running or an AI/ML model compiling format supported by the second device, whether the second device supports a reasoning capability of an AI/ML model, whether the second device supports a handover capability of an AI/ML model, whether the second device supports an activation capability or a deactivation capability of an AI/ML model, whether the second device supports a performance monitoring capability of an AI/ML model, whether the second device supports a transmission capability of an AI/ML model, or whether the second device supports an update capability of an AI/ML model.

Herein j is a positive integer, and 1≤j≤S.

In some embodiments, a type of capability information included in respective capability set in the S capability sets is agreed upon by a protocol, or a type of capability information included in respective capability set in the S capability sets is indicated or configured by a network device.

In some embodiments, the S pieces of information include fifteenth information, and the fifteenth information is used to indicate whether a functional entity for processing an AI/ML related operation is deployed in the second device.

In some embodiments, the fifteenth information includes a first bit. The first bit is used to indicate whether a functional entity for processing an AI/ML related operation is deployed for the second device as a whole, and part of or all functional units in the second device share a capability indicated by the first bit. That is, AI/ML related operations related to functional units in the second device may be processed by using the functional entity for processing the AI/ML related operations.

In some embodiments, the fifteenth information is associated with an AI/ML functional entity type indication information, and the AI/ML functional entity type indication information is used to indicate a type of a functional entity for processing the AI/ML related operation. In at least one embodiment, the AI/ML functional entity type indication information associated with the fifteenth information is configured in a protocol default manner or is configured explicitly by using an additional information field included in the fifteenth information.

In some embodiments, the fifteenth information includes n₁ groups of sub-information, and each group of sub-information in the n₁ groups of sub-information includes one or more bits. Each group of the sub-information is associated with a functional unit or a group of functional units inside the second device, and n₁ is a positive integer.

In a case that each group of the sub-information includes one bit, an i^{th} group of sub-information is used to indicate whether a functional entity for processing an AI/ML related operation is deployed for a functional unit or a group of functional units, associated with the i^{th} group of sub-information, inside the second device.

Alternatively, in a case that each group of the sub-information includes at least two bits, each group of the sub-information includes a first information field and a second information field, a first information field included in an i^{th} group of sub-information is used to indicate whether a functional entity for processing an AI/ML related operation is deployed for a functional unit or a group of functional units, associated with the i^{th} group of sub-information, inside the second device, and a second information field included in the i^{th} group of sub-information is used to indicate a type of a functional entity used for processing an AI/ML related operation and deployed in the functional unit or the group of functional units, associated with the i^{th} group of sub-information, inside the second device.

Alternatively, in a case that each group of the sub-information includes at least one bit, each group of the sub-information includes a third information field, and a third information field included in an i^{th} group of sub-information is used to indicate whether a functional entity for processing an AI/ML related operation is deployed for a functional unit or a group of functional units, associated with the i^{th} group of sub-information, inside the second device, and indicate a type of a functional entity used for processing an AI/ML related operation and deployed in the functional unit or the group of functional units, associated with the i^{th} group of sub-information, inside the second device.

Alternatively, in a case that each group of the sub-information includes at least one bit, an i^{th} group of sub-information is used to indicate a type of a functional entity used for processing an AI/ML related operation and deployed in a functional unit or a group of functional units, associated with the i^{th} group of sub-information, inside the second device.

Herein i is a positive integer, and 1≤i≤n₁.

In some embodiments, the first information field includes one bit, and/or the second information field includes at least one bit.

In some embodiments, each group of the sub-information includes a fourth information field, and a fourth information field included in the i^{th} group of sub-information is used to indicate the functional unit or the group of functional units, associated with the i^{th} group of sub-information, inside the second device.

In some embodiments, the functional unit or the group of functional units, associated with respective group of sub-information in the n₁ groups of sub-information, inside the second device is agreed upon by a protocol.

In some embodiments, the fifteenth information includes information about the type of the functional entity that is used for processing the AI/ML related operation and has been deployed in the second device.

In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the second device; an AI/ML functional entity for processing an AI/ML related operation triggered by a functional unit other than a functional unit or a group of functional units, associated with an AI/ML functional entity, inside the second device; or an AI/ML functional entity capable of processing both an AI/ML related operation triggered by a functional unit or a group of functional units, associated with an AI/ML functional entity, inside the second device and an AI/ML related operation triggered by a functional unit other than a functional unit or a group of functional units, associated with an AI/ML functional entity, inside the second device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of the following operation tasks: a data management task, a storage management task, a computing power management task, or a model management task. In at least one embodiment, the data management task includes but is not limited to at least one of the following: data collection, data storage, data modification, data update, data deletion, data replication, or data forwarding. In at least one embodiment, the storage management task includes but is not limited to at least one of the following: remaining storage size indication, storage reservation, storage allocation, storage sharing, storage recycling, or storage formatting. In at least one embodiment, the computing power management task includes but is not limited to at least one of the following: remaining computing power indication, computing power reservation, computing power allocation, computing power sharing, or computing power recycling. In at least one embodiment, the model management task includes but is not limited to at least one of the following: model training, model verification, model test, model deployment, model replication, model forwarding, model reasoning, model monitoring, model update, model activation, model deactivation, model deletion, or model handover.

In some embodiments, the S pieces of information include sixteenth information, and the sixteenth information is used to indicate whether the second device supports the capability of on-demand configuration of a functional entity for processing an AI/ML related operation.

In some embodiments, the sixteenth information includes a second bit. The second bit is used to indicate whether the second device supports the capability of on-demand configuration of the functional entity for processing the AI/ML related operation, and part of or all functional units in the second device share a capability indicated by the second bit. That is, functional units in the second device shares this capability (certainly, a functional unit set that shares this capability may also be a subset of all functional unit sets supported in the second device), that is, the capability either indicates that all functional units in the second device support on-demand configuration of the functional entity for processing the AI/ML related operation, or indicates that all functional units in the second device do not support on-demand configuration of the functional entity for processing the AI/ML related operation.

In some embodiments, the sixteenth information is associated with type indication information of an AI/ML function entity capable of being configured on demand, where the type indication information of an AI/ML function entity capable of being configured on demand is used to indicate a type of the AI/ML function entity capable of being configured on demand. In at least one embodiment, AI/ML functional entity type indication information is configured in a protocol default manner or is configured explicitly by using an additional information field included in the sixteenth information.

In some embodiments, the sixteenth information includes n₂ groups of sub-information, and each group of sub-information in the n₂ groups of sub-information includes one or more bits. Each group of the sub-information is associated with a functional unit or a group of functional units inside the second device, and n₂ is a positive integer.

In a case that each group of the sub-information includes one bit, an i^{th} group of sub-information is used to indicate whether a functional unit or a group of functional units, associated with the i^{th} group of sub-information, inside the second device supports a capability of on-demand configuration of a functional entity for processing an AI/ML related operation.

Alternatively, in a case that each group of the sub-information includes at least two bits, each group of the sub-information includes a fifth information field and a sixth information field. A fifth information field included in an i^{th} group of sub-information is used to indicate whether a functional unit or a group of functional units, associated with the i^{th} group of sub-information, inside the second device supports a capability of on-demand configuration of a functional entity for processing an AI/ML related operation. A sixth information field included in the i^{th} group of sub-information is used to indicate a set of types of a functional entity used for processing an AI/ML related operation and configured on demand in the functional unit or the group of functional units, associated with the i^{th} group of sub-information, inside the second device.

Alternatively, in a case that each group of the sub-information includes at least one bit, each group of the sub-information includes a seventh information field. A seventh information field included in an i^{th} group of sub-information is used to indicate whether a functional unit or a group of functional units, associated with the i^{th} group of sub-information, inside the second device supports a capability of on-demand configuration of a functional entity for processing an AI/ML related operation, and indicate a set of types of a functional entity used for processing an AI/ML related operation and configured on demand in the functional unit or the group of functional units, associated with the i^{th} group of sub-information, inside the second device.

Alternatively, in a case that each group of the sub-information includes at least one bit, an i^{th} group of sub-information is used to indicate a type of a functional entity used for processing an AI/ML related operation and configured on demand in a functional unit or a group of functional units, associated with the i^{th} group of sub-information, inside the second device.

Herein i is a positive integer, and 1≤i≤n₂.

In some embodiments, the fifth information field includes one bit, and/or the sixth information field includes at least one bit.

In some embodiments, each bit of the sixth information field is associated with a type of or a group of types of AI/ML functional entities, and the value of each bit included in the sixth information field is used to determine whether the type of or the group of types of AI/ML functional entities associated with the value of respective bit supports on-demand configuration; or each type of bit status value of the sixth information field is associated with a type of or a group of types of AI/ML functional entities, and each type of bit status value of the sixth information field indicates that the type of or the group of types of AI/ML function entities associated with the respective type of bit status value supports on-demand configuration.

In some embodiments, the type of or the group of types of AI/ML function entities associated with respective bit of the sixth information field is agreed upon by a protocol, or the type of or the group of types of AI/ML function entities associated with respective type of bit status value of the sixth information field is agreed upon by a protocol.

In some embodiments, each group of the sub-information includes an eighth information field, and an eighth information field included in the i^{th} group of sub-information is used to indicate the functional unit or the group of functional units, associated with the i^{th} group of sub-information, inside the second device.

In some embodiments, the functional unit or the group of functional units, associated with respective group of sub-information in the n₂ groups of sub-information, inside the second device is agreed upon by a protocol.

In some embodiments, the sixteenth information includes type information of at least one functional entity for processing the AI/ML related operation and supported by the second device.

In some embodiments, the sixteenth information is associated with configuration mode information, and the configuration mode information is used to indicate a mode of triggering establishment of an AI/ML functional entity configured on demand.

In some embodiments, the mode of triggering establishment of the AI/ML functional entity configured on demand includes at least one of the following: the second device autonomously triggering establishment of the AI/ML functional entity configured on demand, the first device actively requesting the second device to establish the AI/ML functional entity configured on demand, or the second device establishing the AI/ML functional entity configured on demand after the second device initiates an establishment request and obtains an acknowledgement from the first device.

In some embodiments, the configuration mode information associated with the sixteenth information is agreed upon by a protocol. For example, the protocol directly agrees that the meaning of the configuration mode information associated with the sixteenth information is that an AI/ML functional entity configured on demand is established based on triggering of the second device, that is, all AI/ML functional entities configured on demand and determined by the sixteenth information can be established on the second device side only in a manner of triggering of the second device.

In some embodiments, the sixteenth information includes a ninth information field, and the ninth information field is used to indicate the configuration mode information associated with the sixteenth information.

In some embodiments, in a case that the ninth information field is used to indicate the configuration mode information associated with the sixteenth information, an indication granularity of the ninth information field includes one of the following: a granularity based on the second device, a granularity based on a sub-information group included in the sixteenth information, and a granularity based on a type of the AI/ML functional entity configured on demand.

In some embodiments, in a case that the indication granularity of the ninth information field is the granularity based on the second device, configuration modes corresponding to all AI/ML function entities configured on demand and supported by the first second are the same. That is, configuration modes corresponding to all the AI/ML functional entities configured on demand and supported by the second device are the same. A specific configuration mode is provided by using common configuration mode information.

In some embodiments, in a case that the indication granularity of the ninth information field is the granularity based on a sub-information group included in the sixteenth information, configuration modes corresponding to all AI/ML function entities configured on demand and supported by respective sub-information group included in the sixteenth information are the same. That is, the configuration is performed according to a granularity of a sub-information group of the sixteenth information (each group of sub-information is associated with a functional unit or a group of functional units inside the second device, or may be configured according to a granularity of a functional unit inside the second device). In this manner, regardless of whether one or more types of AI/ML functional entities are configured on demand and correspondingly supported by a group of sub-information of the sixteenth information, configuration modes corresponding to all AI/ML functional entities configured on demand and supported by the group of sub-information are the same. A specific configuration mode is provided by using configuration mode information associated with a sub-information group.

In some embodiments, in a case that the indication granularity of the ninth information field is the granularity based on a type of the AI/ML functional entity configured on demand, each type of the AI/ML functional entity configured on demand and supported by the sixteenth information is independently associated with configuration mode information used to indicate a configuration mode supported by the type of the AI/ML functional entity. That is, each type of the AI/ML functional entity configured on demand and supported by the sixteenth information is independently associated with one piece of configuration mode information, which is used to indicate a configuration mode supported by the type of the AI/ML functional entity.

In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the second device; an AI/ML functional entity for processing an AI/ML related operation triggered by a functional unit other than a functional unit or a group of functional units, associated with an AI/ML functional entity, inside the second device; or an AI/ML functional entity capable of processing both an AI/ML related operation triggered by a functional unit or a group of functional units, associated with an AI/ML functional entity, inside the second device and an AI/ML related operation triggered by a functional unit other than a functional unit or a group of functional units, associated with an AI/ML functional entity, inside the second device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of the following operation tasks: a data management task, a storage management task, a computing power management task, or a model management task. In at least one embodiment, the data management task includes but is not limited to at least one of the following: data collection, data storage, data modification, data update, data deletion, data replication, or data forwarding. In at least one embodiment, the storage management task includes but is not limited to at least one of the following: remaining storage size indication, storage reservation, storage allocation, storage sharing, storage recycling, or storage formatting. In at least one embodiment, the computing power management task includes but is not limited to at least one of the following: remaining computing power indication, computing power reservation, computing power allocation, computing power sharing, or computing power recycling. In at least one embodiment, the model management task includes but is not limited to at least one of the following: model training, model verification, model test, model deployment, model replication, model forwarding, model reasoning, model monitoring, model update, model activation, model deactivation, model deletion, or model handover.

In some embodiments, the S pieces of information include seventeenth information, and the seventeenth information is used to indicate whether the second device supports the capability of data collection for the AI/ML purpose.

In some embodiments, the seventeenth information includes a third bit. The third bit is used to indicate whether the second device as a whole supports the capability of data collection for the AI/ML purpose. That is, the seventeenth information includes one bit, which is used to indicate whether the second device as a whole supports the capability of data collection for the AI/ML purpose, and types of collected data is not required to be identified.

In some embodiments, the seventeenth information is associated with a type of collected data.

In some embodiments, the type of collected data associated with the seventeenth information is agreed upon by a protocol, or the type of collected data associated with the seventeenth information is indicated by an information field included in the seventeenth information.

In some embodiments, the seventeenth information includes n₃ groups of sub-information, and each group of sub-information in the n₃ groups of sub-information includes one or more bits. Each group of the sub-information is associated with a functional unit or a group of functional units inside the second device, and n₃ is a positive integer.

In a case that each group of the sub-information includes one bit, an i^{th} group of sub-information is used to indicate whether a functional unit or a group of functional units, associated with the i^{th} group of sub-information, inside the second device supports the capability of data collection for the AI/ML purpose.

Alternatively, in a case that each group of the sub-information includes at least two bits, each group of the sub-information includes a tenth information field and an eleventh information field. A tenth information field included in an i^{th} group of sub-information is used to indicate whether a functional unit or a group of functional units, associated with the i^{th} group of sub-information, inside the second device supports the capability of data collection for the AI/ML purpose, and an eleventh information field included in the i^{th} group of sub-information is used to indicate a set of types of collected data.

Alternatively, in a case that each group of the sub-information includes at least one bit, each group of the sub-information includes a twelfth information field. A twelfth information field included in an i^{th} group of sub-information is used to indicate whether a functional unit or a group of functional units, associated with the i^{th} group of sub-information, inside the second device supports the capability of data collection for the AI/ML purpose, and indicate a set of types of collected data.

Alternatively, in a case that each group of the sub-information includes at least one bit, an i^{th} group of sub-information is used to indicate a set of types of data collected by a functional unit or a group of functional units, associated with the i^{th} group of sub-information, inside the second device.

Herein i is a positive integer, and 1≤i≤n₃.

In some embodiments, the tenth information field includes one bit, and/or the eleventh information field includes at least one bit.

In some embodiments, each bit of the eleventh information field is associated with a type of or a group of types of collected data, and the value of each bit included in the eleventh information field is used to determine whether the type of or the group of types of collected data associated with the value of respective bit supports being collected by the second device; or each type of bit status value of the eleventh information field is associated with a type of or a group of types of collected data, and each type of bit status value of the eleventh information field indicates that the type of or the group of types of collected data associated with respective type of bit status value supports being collected by the second device.

In some embodiments, the type of or the group of types of collected data associated with respective bit of the eleventh information field is agreed upon by a protocol, or the type of or the group of types of collected data associated with respective type of bit status value of the eleventh information field is agreed upon by a protocol.

In some embodiments, each group of the sub-information includes a thirteenth information field, and a thirteenth information field included in the i^{th} group of sub-information is used to indicate the functional unit or the group of functional units, associated with the i^{th} group of sub-information, inside the second device.

In some embodiments, the functional unit or the group of functional units, associated with respective group of sub-information in the n₃ groups of sub-information, inside the second device is agreed upon by a protocol.

In some embodiments, the seventeenth information includes type information of at least a type of or a group of types of collected data supported by the second device.

In some embodiments, the seventeenth information is associated with data collection trigger type indication information.

A bit status value of the data collection trigger type indication information is used to indicate that the second device supports only data collection triggered by the second device, or a bit status value of the data collection trigger type indication information is used to indicate that the second device supports only data collection triggered by the first device, or a bit status value of the data collection trigger type indication information is used to indicate that the second device supports both data collection triggered by the second device and data collection triggered by the first device.

In some embodiments, the data collection trigger type indication information associated with the seventeenth information is agreed upon by a protocol, or the data collection trigger type indication information associated with the seventeenth information is indicated by an information field in the seventeenth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the S pieces of information include eighteenth information, and the eighteenth information is used to indicate whether the second device supports the capability of data reporting for the AI/ML purpose.

In some embodiments, the eighteenth information includes a fourth bit. The fourth bit is used to indicate whether the second device as a whole supports the capability of data reporting for the AI/ML purpose. That is, the eighteenth information includes one bit, which is used to indicate whether the second device as a whole supports the capability of data reporting for the AI/ML purpose, and types of reported data are not required to be identified.

In some embodiments, the eighteenth information is associated with a type of reported data.

In some embodiments, the type of reported data associated with the eighteenth information is agreed upon by a protocol, or the type of reported data associated with the eighteenth information is indicated by an information field included in the eighteenth information.

In some embodiments, the eighteenth information includes n₄ groups of sub-information, and each group of sub-information in the n₄ groups of sub-information includes one or more bits. Each group of the sub-information is associated with a functional unit or a group of functional units inside the second device, and n₄ is a positive integer.

In a case that each group of the sub-information includes one bit, an i^{th} group of sub-information is used to indicate whether a functional unit or a group of functional units, associated with the i^{th} group of sub-information, inside the second device supports the capability of data reporting for the AI/ML purpose.

Alternatively, in a case that each group of the sub-information includes at least two bits, each group of the sub-information includes a fourteenth information field and a fifteenth information field. A fourteenth information field included in an i^{th} group of sub-information is used to indicate whether a functional unit or a group of functional units, associated with the i^{th} group of sub-information, inside the second device supports the capability of data reporting for the AI/ML purpose, and a fifteenth information field included in the i^{th} group of sub-information is used to indicate a set of types of reported data.

Alternatively, in a case that each group of the sub-information includes at least one bit, each group of the sub-information includes a sixteenth information field. A sixteenth information field included in an i^{th} group of sub-information is used to indicate whether a functional unit or a group of functional units, associated with the i^{th} group of sub-information, inside the second device supports the capability of data reporting for the AI/ML purpose, and indicate a set of types of reported data.

Alternatively, in a case that each group of the sub-information includes at least one bit, an i^{th} group of sub-information is used to indicate a set of types of data reported by a functional unit or a group of functional units, associated with the i^{th} group of sub-information, inside the second device.

Herein i is a positive integer, and 1≤i≤n₄.

In some embodiments, the fourteenth information field includes one bit, and/or the fifteenth information field includes at least one bit.

In some embodiments, each bit of the fifteenth information field is associated with a type of or a group of types of reported data, and the value of each bit included in the fifteenth information field is used to determine whether the type of or the group of types of reported data associated with the value of respective bit supports being reported by the second device. Alternatively, each type of bit status value of the fifteenth information field is associated with a type of or a group of types of reported data, and each type of bit status value of the fifteenth information field indicates that the type of or the group of types of reported data associated with respective type of bit status value supports being reported by the second device.

In some embodiments, the type of or the group of types of reported data associated with respective bit of the fifteenth information field is agreed upon by a protocol, or the type of or the group of types of reported data associated with respective type of bit status value of the fifteenth information field is agreed upon by a protocol.

In some embodiments, each group of the sub-information includes a seventeenth information field, and a seventeenth information field included in the i^{th} group of sub-information is used to indicate the functional unit or the group of functional units, associated with the i^{th} group of sub-information, inside the second device.

In some embodiments, the functional unit or the group of functional units, associated with respective group of sub-information in the n₄ groups of sub-information, inside the second device is agreed upon by a protocol.

In some embodiments, the eighteenth information includes type information of at least a type of or a group of types of reported data supported by the second device.

In some embodiments, the eighteenth information is associated with a data reporting trigger type indication information.

A bit status value of the data reporting trigger type indication information is used to indicate that the second device supports only data reporting triggered by the second device, or a bit status value of the data reporting trigger type indication information is used to indicate that the second device supports only data reporting triggered by the second device, or a bit status value of the data reporting trigger type indication information is used to indicate that the second device supports both data reporting triggered by the second device and data reporting triggered by the second device.

In some embodiments, the data reporting trigger type indication information associated with the eighteenth information is agreed upon by a protocol, or the data reporting trigger type indication information associated with the eighteenth information is indicated by an information field in the eighteenth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the S pieces of information include nineteenth information, and the nineteenth information is used to indicate whether the second device supports the capability of data measurement for the AI/ML purpose.

In some embodiments, the nineteenth information includes a fifth bit. The fifth bit is used to indicate whether the second device as a whole supports the capability of data measurement for the AI/ML purpose.

In some embodiments, the nineteenth information is associated with a type of measured data.

In some embodiments, the type of measured data associated with the nineteenth information is agreed upon by a protocol, or the type of measured data associated with the nineteenth information is indicated by an information field included in the nineteenth information.

In some embodiments, the nineteenth information includes n₅ groups of sub-information, and each group of sub-information in the n₅ groups of sub-information includes one or more bits. Each group of the sub-information is associated with a functional unit or a group of functional units inside the second device, and n₅ is a positive integer.

In a case that each group of the sub-information includes one bit, an i^{th} group of sub-information is used to indicate whether a functional unit or a group of functional units, associated with the i^{th} group of sub-information, inside the second device supports the capability of data measurement for the AI/ML purpose.

Alternatively, in a case that each group of the sub-information includes at least two bits, each group of the sub-information includes an eighteenth information field and a nineteenth information field. An eighteenth information field included in an i^{th} group of sub-information is used to indicate whether a functional unit or a group of functional units, associated with the i^{th} group of sub-information, inside the second device supports the capability of data measurement for the AI/ML purpose, and a nineteenth information field included in the i^{th} group of sub-information is used to indicate a set of types of measured data.

Alternatively, in a case that each group of the sub-information includes at least one bit, each group of the sub-information includes a twentieth information field. A twentieth information field included in an i^{th} group of sub-information is used to indicate whether a functional unit or a group of functional units, associated with the i^{th} group of sub-information, inside the second device supports the capability of data measurement for the AI/ML purpose, and indicate a set of types of measured data.

Alternatively, in a case that each group of the sub-information includes at least one bit, an i^{th} group of sub-information is used to indicate a set of types of data measured by a functional unit or a group of functional units, associated with the i^{th} group of sub-information, inside the second device.

Herein i is a positive integer, and 1≤i≤n₅.

In some embodiments, the eighteenth information field includes one bit, and/or the nineteenth information field includes at least one bit.

In some embodiments, each bit of the nineteenth information field is associated with a type of or a group of types of measured data, and the value of each bit included in the nineteenth information field is used to determine whether the type of or the group of types of measured data associated with the value of respective bit supports being measured by the second device; or each type of bit status value of the nineteenth information field is associated with a type of or a group of types of measured data, and each type of bit status value of the nineteenth information field indicates that the type of or the group of types of measured data associated with respective type of bit status value supports being measured by the second device.

In some embodiments, the type of or the group of types of measured data associated with respective bit of the nineteenth information field is agreed upon by a protocol, or the type of or the group of types of measured data associated with respective type of bit status value of the nineteenth information field is agreed upon by a protocol.

In some embodiments, each group of the sub-information includes a twenty-first information field, and a twenty-first information field included in the i^{th} group of sub-information is used to indicate the functional unit or the group of functional units, associated with the i^{th} group of sub-information, inside the second device.

In some embodiments, the functional unit or the group of functional units, associated with respective group of sub-information in the n₅ groups of sub-information, inside the second device is agreed upon by a protocol.

In some embodiments, the nineteenth information includes type information of at least a type of or a group of types of measured data supported by the second device. In some embodiments, the nineteenth information is associated with data measurement trigger type indication information.

A bit status value of the data measurement trigger type indication information is used to indicate that the second device supports only data measurement triggered by the second device, or a bit status value of the data measurement trigger type indication information is used to indicate that the second device supports only data measurement triggered by the first device, or a bit status value of the data measurement trigger type indication information is used to indicate that the second device supports both data measurement triggered by the second device and data measurement triggered by the first device.

In some embodiments, the data measurement trigger type indication information associated with the nineteenth information is agreed upon by a protocol, or the data measurement trigger type indication information associated with the nineteenth information is indicated by an information field in the nineteenth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, capabilities in the seventeenth information, the eighteenth information, and the nineteenth information may be further subdivided into at least one of a data processing capability, a data storage capability, or a data calculation capability.

In some embodiments, the capabilities in the seventeenth information, the eighteenth information, and the nineteenth information are allowed to be combined into one type of capability for reporting. The second device either supports all capabilities or no capability. In at least one embodiment, the combined capability may be associated with data type information capable of being processed. The combined capability may alternatively be reported according to at least one of the following granularities: a granularity based on a functional unit, a granularity based on an identity of an AI/ML model, or a granularity based on a type of processed data.

In some embodiments, the S pieces of information include twentieth information, and the twentieth information is used to indicate whether the second device supports the capability of offline AI/ML model training.

In some embodiments, the twentieth information is associated with an offline AI/ML model training type indication information.

A bit status value of the offline AI/ML model training type indication information is used to indicate that the second device supports only offline AI/ML model training triggered by the second device, or a bit status value of the offline AI/ML model training type indication information is used to indicate that the second device supports only offline AI/ML model training triggered by the first device, or a bit status value of the offline AI/ML model training type indication information is used to indicate that the second device supports both offline AI/ML model training triggered by the second device and offline AI/ML model training triggered by the first device.

In some embodiments, the offline AI/ML model training type indication information associated with the twentieth information is agreed upon by a protocol, or the offline AI/ML model training type indication information associated with the twentieth information is indicated by an information field in the twentieth information.

In some embodiments, the M pieces of information include twenty-first information, and the twenty-first information is used to indicate whether the second device supports the capability of online AI/ML model training.

In some embodiments, the twenty-first information is associated with an online AI/ML model training type indication information.

A bit status value of the online AI/ML model training type indication information is used to indicate that the second device supports only online AI/ML model training triggered by the second device, or a bit status value of the online AI/ML model training type indication information is used to indicate that the second device supports only online AI/ML model training triggered by the first device, or a bit status value of the online AI/ML model training type indication information is used to indicate that the second device supports both online AI/ML model training triggered by the second device and online AI/ML model training triggered by the first device.

In some embodiments, the online AI/ML model training type indication information associated with the twenty-first information is agreed upon by a protocol, or the online AI/ML model training type indication information associated with the twenty-first information is indicated by an information field in the twenty-first information.

In some embodiments, capabilities in the twentieth information and the twenty-first information are allowed to be combined into one type of capability for reporting. The second device supports either all capabilities or no capability. In at least one embodiment, the combined capability may alternatively be associated with training type indication information. The combined capability may alternatively be reported according to at least one of the following granularities: a granularity based on a functional unit, a granularity based on an identity of an AI/ML model, or a granularity based on a type of associated training.

In some embodiments, the M pieces of information include twenty-second information, and the twenty-second information is used to indicate the AI/ML model running or the AI/ML model compiling format supported by the second device. There may be differences in operating or compilation environments supported by different second devices. Reporting the capability helps the first device to transmit, for the second device, an AI/ML model suitable for a configuration environment of the second device.

In some embodiments, the M pieces of information include twenty-third information, and the twenty-third information is used to indicate whether the second device supports the reasoning capability of the AI/ML model.

In some embodiments, the twenty-third information is associated with an AI/ML model reasoning type indication information.

A bit status value of the AI/ML model reasoning type indication information is used to indicate that the second device supports only non-federated reasoning or centralized reasoning, or a bit status value of the AI/ML model reasoning type indication information is used to indicate that the second device supports only federated reasoning or distributed reasoning, or a bit status value of the AI/ML model reasoning type indication information is used to indicate that the second device supports federated reasoning and non-federated reasoning.

In some embodiments, the AI/ML model reasoning type indication information associated with the twenty-third information is agreed upon by a protocol, or the AI/ML model reasoning type indication information associated with the twenty-third information is indicated by an information field in the twenty-third information.

In some embodiments, the M pieces of information include twenty-fourth information, and the twenty-fourth information is used to indicate whether the second device supports the handover capability of the AI/ML model.

In some embodiments, the twenty-fourth information is associated with an AI/ML model handover type indication information.

A bit status value of the AI/ML model handover type indication information is used to indicate that the AI/ML model is allowed to be handed over only by the second device, or a bit status value of the AI/ML model handover type indication information is used to indicate that the AI/ML model is allowed to be handed over only by the first device, or a bit status value of the AI/ML model handover type indication information is used to indicate that the AI/ML model is allowed to be handed over by the second device or the first device.

In some embodiments, the AI/ML model handover type indication information associated with the twenty-fourth information is agreed upon by a protocol, or the AI/ML model handover type indication information associated with the twenty-fourth information is indicated by an information field in the twenty-fourth information.

In some embodiments, the M pieces of information include twenty-fifth information, and the twenty-fifth information is used to indicate whether the second device supports the activation capability or the deactivation capability of the AI/ML model.

In some embodiments, the twenty-fifth information is associated with AI/ML model activation/deactivation type indication information.

A bit status value of the AI/ML model activation/deactivation type indication information is used to indicate that the AI/ML model is allowed to be activated or deactivated only by the second device, or a bit status value of the AI/ML model activation/deactivation type indication information is used to indicate that the AI/ML model is allowed to be activated or deactivated only by the first device, or a bit status value of the AI/ML model activation/deactivation type indication information is used to indicate that the AI/ML model is allowed to be activated or deactivated by the second device or the first device.

In some embodiments, the AI/ML model activation/deactivation type indication information associated with the twenty-fifth information is agreed upon by a protocol, or the AI/ML model activation/deactivation type indication information associated with the twenty-fifth information is indicated by an information field in the twenty-fifth information.

In some embodiments, the M pieces of information include twenty-sixth information, and the twenty-sixth information is used to indicate whether the second device supports the performance monitoring capability of the AI/ML model.

In some embodiments, the twenty-sixth information is associated with AI/ML model performance monitoring type indication information.

A bit status value of the AI/ML model performance monitoring type indication information is used to indicate that performance monitoring of the AI/ML model is allowed to be performed only by the second device, or a bit status value of the AI/ML model performance monitoring type indication information is used to indicate that performance monitoring of the AI/ML model is allowed to be performed only by the first device, or a bit status value of the AI/ML model performance monitoring type indication information used to indicate that performance monitoring of the AI/ML model is allowed to be performed by the second device or the first device.

In some embodiments, the AI/ML model performance monitoring type indication information associated with the twenty-sixth information is agreed upon by a protocol, or the AI/ML model performance monitoring type indication information associated with the twenty-sixth information is indicated by an information field in the twenty-sixth information.

In some embodiments, the S pieces of information include twenty-seventh information, and the twenty-seventh information is used to indicate whether the second device supports the transmission capability of the AI/ML model.

In some embodiments, the twenty-seventh information is associated with an AI/ML model transmission type indication information.

A bit status value of the AI/ML model transmission type indication information is used to indicate that the second device supports only downloading of the AI/ML model, or a bit status value of the AI/ML model transmission type indication information is used to indicate that the second device supports only uploading of the AI/ML model, or a bit status value of the AI/ML model transmission type indication information is used to indicate that the second device supports both downloading of the AI/ML model and uploading of the AI/ML model.

In some embodiments, the AI/ML model transmission type indication information associated with the twenty-seventh information is agreed upon by a protocol, or the AI/ML model transmission type indication information associated with the twenty-seventh information is indicated by an information field in the twenty-seventh information.

In some embodiments, the transmission capability of the AI/ML model includes a data transmission format of the AI/ML model, and the data transmission format of the AI/ML model is used to indicate an AI/ML model transmission format supported by the second device. Certainly, the transmission capability of the AI/ML model may further include another AI/ML model transmission information, which is not limited in embodiments of this application.

In some embodiments, the S pieces of information include twenty-eighth information, and the twenty-eighth information is used to indicate whether the second device supports the update capability of the AI/ML model.

In some embodiments, the twenty-eighth information is associated with AI/ML model update type indication information.

A bit status value of the AI/ML model update type indication information is used to indicate that the AI/ML model is allowed to be updated only by the second device, or a bit status value of the AI/ML model update type indication information is used to indicate that the AI/ML model is allowed to be updated only by the first device, or a bit status value of the AI/ML model update type indication information is used to indicate that the AI/ML model is allowed to be updated by the second device or the first device.

In some embodiments, the AI/ML model update type indication information associated with the twenty-eighth information is agreed upon by a protocol, or the AI/ML model update type indication information associated with the twenty-eighth information is indicated by an information field in the twenty-eighth information.

In some embodiments, the first device transmits a third message to the second device.

The third message includes a capability update indication information, and the capability update indication information is used to indicate that the first AI/ML related capability information is updated.

In some embodiments, the third message is one of following: a NAS message, an AS message, an interface message, or an AI/ML dedicated message. In at least one embodiment, the AS message may be an RRC message, an L2 message, or an L1 message, and the interface message may be an NG message, an Xn message, an F1 message, or an E1 message.

In some embodiments, the capability update indication information includes a sixth bit, and the sixth bit is used to indicate that the first AI/ML related capability information is updated.

Alternatively, the capability update indication information includes a plurality of bits, where each bit of the plurality of bits is associated with a piece of or a group of pieces of AI/ML related capability information, and each bit is used to indicate whether the piece of or the group of pieces of AI/ML related capability information corresponding to respective bit is updated.

In some embodiments, the capability update indication information is triggered based on a preset event, and the preset event is agreed upon by a protocol, or configured by using the second device.

In some embodiments, the first device receives a fourth message transmitted by the second device.

The fourth message is used to instruct the first device to report the updated first AI/ML related capability information, or the fourth message is used to instruct the first device to report updated capability information in the first AI/ML related capability information.

In some embodiments, the fourth message is one of following: a NAS message, an AS message, an interface message, or an AI/ML dedicated message. In at least one embodiment, the AS message may be an RRC message, an L2 message, or an L1 message, and the interface message may be an NG message, an Xn message, an F1 message, or an E1 message.

In some embodiments, the fourth message includes a capability type indication information, and the capability type indication information is used to indicate a type of the updated capability information reported by the first device.

In some embodiments, the fourth message is a response message of the third message or a message actively triggered by the second device.

In some embodiments, the first device transmits a fifth message to the second device.

The fifth message includes the updated first AI/ML related capability information, or the fifth message includes updated capability information specified by the second device for reporting.

In some embodiments, the fifth message is one of the following: a NAS message, an AS message, an interface message, or an AI/ML dedicated message. In at least one embodiment, the AS message may be an RRC message, an L2 message, or an L1 message, and the interface message may be an NG message, an Xn message, an F1 message, or an E1 message.

In some embodiments, in a case that the first device is a terminal device, a functional unit inside the first device includes at least one of the following: a functional entity at a non-access stratum (NAS) layer, a functional entity at a service data adaptation protocol (SDAP) layer, a functional entity at a radio resource control (RRC) layer, a functional entity at a packet data convergence protocol (PDCP) layer, a functional entity at a radio link control (RLC) layer, a functional entity at a backhaul adaptation protocol (BAP) layer, a functional entity at a medium access control (MAC) layer, or a functional entity at a physical layer (PHY).

In some embodiments, in a case that the first device is an access network device, a functional unit inside the first device includes at least one of the following: a centralized unit (CU), a distributed unit (DU), a centralized unit control plane (CU-CP), a centralized unit user plane (UP-UP), a functional entity at a NAS layer, a functional entity at an SDAP layer, a functional entity at an RRC layer, a functional entity at a PDCP layer, a functional entity at an RLC layer, a functional entity at a MAC layer, a functional entity at a PHY layer, or a functional entity at a BAP layer.

In some embodiments, in a case that the first device is a core network device, a functional unit inside the first device includes at least one of the following: an access and mobility management function (AMF) network element, an authentication server function (AUSF) network element, a user plane function (UPF) network element, a session management function (SMF) network element, a location management function (LMF) network element, a policy control function (PCF) network element, or a unified data management (UDM) network element.

In some embodiments, the messages (that is, the foregoing first message to the fifth message) is one of the following: a NAS message, an AS message, an interface message, or an AI/ML dedicated message. In at least one embodiment, the AS message may be an RRC message, an L2 message, or an L1 message, and the interface message may be an NG message, an Xn message, an F1 message, or an E1 message.

Therefore, in embodiments of this application, the first device may transmit first AI/ML related capability information to the second device, and M pieces of information included in the first AI/ML related capability information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model. That is, according to the foregoing technical solutions, AI/ML capability interaction in different types and at different granularities may be implemented. AI/ML related capability information may be flexibly interacted between the first device and the second device, so that an AI/ML function is applied by a communications device in a refined manner.

The foregoing describes the method embodiments of this application in detail with reference to FIG. 2. The following describes apparatus embodiments of this application in detail with reference to FIG. 3 to FIG. 7. It should be understood that the apparatus embodiments are corresponding to the method embodiments. For similar descriptions, reference may be made to the method embodiments.

FIG. 3 is a schematic block diagram of a wireless communications device 300 according to an embodiment of this application. The wireless communications device 300 is a first device. As shown in FIG. 3, the wireless communications device 300 includes a first communications unit 310.

The first communications unit 310 is configured to transmit a first message to a second device.

The first message includes first artificial intelligence AI/machine learning ML related capability information, the first AI/ML related capability information is associated with the first device, the first AI/ML related capability information includes M pieces of information, and M is a positive integer.

The M pieces of information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

In some embodiments, the M pieces of information include first information, and the first information is used to indicate whether a functional entity for processing an AI/ML related operation is deployed in the first device.

In some embodiments, the first information includes a first bit.

The first bit is used to indicate whether a functional entity for processing an AI/ML related operation is deployed for the first device as a whole, and part of or all functional units in the first device share a capability indicated by the first bit.

In some embodiments, the first information includes n₁ groups of sub-information, each group of sub-information in the n₁ groups of sub-information includes one or more bits, each group of the sub-information is associated with a functional unit or a group of functional units inside the first device, and n₁ is a positive integer.

In a case that each group of the sub-information includes one bit, an i^{th} group of sub-information is used to indicate whether a functional entity for processing an AI/ML related operation is deployed for a functional unit or a group of functional units, associated with the i^{th} group of sub-information, inside the first device.

Alternatively, in a case that each group of the sub-information includes at least two bits, each group of the sub-information includes a first information field and a second information field, a first information field included in an i^{th} group of sub-information is used to indicate whether a functional entity for processing an AI/ML related operation is deployed for a functional unit or a group of functional units, associated with the i^{th} group of sub-information, inside the first device, and a second information field included in the i^{th} group of sub-information is used to indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, each group of the sub-information includes a third information field, and a third information field included in an i^{th} group of sub-information is used to indicate whether a functional entity for processing an AI/ML related operation is deployed for a functional unit or a group of functional units, associated with the i^{th} group of sub-information, inside the first device, and indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and deployed in a functional unit or a group of functional units, associated with the i^{th} group of sub-information, inside the first device.

Herein i is a positive integer, and 1≤i≤n.

In some embodiments, the first information field includes one bit, and/or the second information field includes at least one bit.

In some embodiments, each group of the sub-information includes a fourth information field, and a fourth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₁ groups of sub-information, inside the first device is agreed upon by a protocol.

In some embodiments, the M pieces of information include second information, and the second information is used to indicate whether the first device supports the capability of on-demand configuration of a functional entity for processing an AI/ML related operation.

In some embodiments, the second information includes a second bit.

The second bit is used to indicate whether the first device supports a capability of on-demand configuration of a functional entity for processing an AI/ML related operation, and part of or all functional units in the first device share the capability indicated by the second bit.

In some embodiments, the second information includes n₂ groups of sub-information, each group of sub-information in the n₂ groups of sub-information includes one or more bits, each group of the sub-information is associated with a functional unit or a group of functional units inside the first device, and n₂ is a positive integer.

In a case that each group of the sub-information includes one bit, an i^{th} group of sub-information is used to indicate whether a functional unit or a group of functional units, associated with the i^{th} group of sub-information, inside the first device supports a capability of on-demand configuration of a functional entity for processing an AI/ML related operation.

Alternatively, in a case that each group of the sub-information includes at least two bits, each group of the sub-information includes a fifth information field and a sixth information field. A fifth information field included in an i^{th} group of sub-information is used to indicate whether a functional unit or a group of functional units, associated with the i^{th} group of sub-information, inside the first device supports a capability of on-demand configuration of a functional entity for processing an AI/ML related operation. A sixth information field included in the i^{th} group of sub-information is used to indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, each group of the sub-information includes a seventh information field. A seventh information field included in an i^{th} group of sub-information is used to indicate whether a functional unit or a group of functional units, associated with the i^{th} group of sub-information, inside the first device supports a capability of on-demand configuration of a functional entity for processing an AI/ML related operation, and indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and configured on demand in a functional unit or a group of functional units, associated with the i^{th} group of sub-information, inside the first device.

Herein i is a positive integer, and 1≤i≤n₂.

In some embodiments, the fifth information field includes one bit, and/or the sixth information field includes at least one bit.

In some embodiments, each bit of the sixth information field is associated with a type of or a group of types of AI/ML functional entities, and the value of each bit included in the sixth information field is used to determine whether the type of or the group of types of AI/ML functional entities associated with the value of respective bit supports on-demand configuration.

Alternatively, each type of bit status value of the sixth information field is associated with a type of or a group of types of AI/ML functional entities, and each type of bit status value of the sixth information field indicates that the type of or the group of types of AI/ML function entities associated with the respective type of bit status value supports on-demand configuration.

In some embodiments, the type of or the group of types of AI/ML function entities associated with respective bit of the sixth information field is agreed upon by a protocol, or the type of or the group of types of AI/ML function entities associated with respective type of bit status value of the sixth information field is agreed upon by a protocol.

In some embodiments, each group of the sub-information includes an eighth information field, and an eighth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₂ groups of sub-information, inside the first device is agreed upon by a protocol.

In some embodiments, the second information is associated with configuration mode information, and the configuration mode information is used to indicate a mode of triggering establishment of an AI/ML functional entity configured on demand.

In some embodiments, the mode of triggering establishment of the AI/ML functional entity configured on demand includes at least one of the following: the first device autonomously triggering establishment of the AI/ML functional entity configured on demand, the second device actively requesting the first device to establish the AI/ML functional entity configured on demand, or the first device establishing the AI/ML functional entity configured on demand after the first device initiates an establishment request and obtains an acknowledgement from the second device.

In some embodiments, the configuration mode information associated with the second information is agreed upon by a protocol.

Alternatively, the second information includes a ninth information field, and the ninth information field is used to indicate the configuration mode information associated with the second information.

In some embodiments, in a case that the ninth information field is used to indicate the configuration mode information associated with the second information, an indication granularity of the ninth information field includes one of the following: a granularity based on the first device, a granularity based on a sub-information group included in the second information, and a granularity based on a type of the AI/ML functional entity configured on demand.

In some embodiments, in a case that the indication granularity of the ninth information field is the granularity based on the first device, configuration modes corresponding to all AI/ML function entities configured on demand and supported by the first device are the same.

Alternatively, in a case that the indication granularity of the ninth information field is the granularity based on a sub-information group included in the second information, configuration modes corresponding to all AI/ML function entities configured on demand and supported by respective sub-information group included in the second information are the same.

Alternatively, in a case that the indication granularity of the ninth information field is the granularity based on a type of the AI/ML functional entity configured on demand, each type of the AI/ML functional entity configured on demand and supported by the second information is independently associated with configuration mode information used to indicate a configuration mode supported by the type of the AI/ML functional entity.

In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the first device; an AI/ML functional entity for processing an AI/ML related operation triggered by a functional unit other than a functional unit or a group of functional units, associated with an AI/ML functional entity, inside the first device; or an AI/ML functional entity capable of processing both an AI/ML related operation triggered by a functional unit or a group of functional units, associated with an AI/ML functional entity, inside the first device and an AI/ML related operation triggered by a functional unit other than a functional unit or a group of functional units, associated with an AI/ML functional entity, inside the first device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of the following operation tasks: a data management task, a storage management task, a computing power management task, or a model management task.

The data management task includes at least one of following: data collection, data storage, data modification, data update, data deletion, data replication, or data forwarding.

The storage management task includes at least one of the following: remaining storage size indication, storage reservation, storage allocation, storage sharing, storage recycling, or storage formatting.

The computing power management task includes at least one of the following: remaining computing power indication, computing power reservation, computing power allocation, computing power sharing, or computing power recycling.

The model management task includes at least one of the following: model training, model verification, model test, model deployment, model replication, model forwarding, model reasoning, model monitoring, model update, model activation, model deactivation, model deletion, or model handover.

In some embodiments, the M pieces of information include third information, and the third information is used to indicate whether the first device supports the capability of data collection for the AI/ML purpose.

In some embodiments, the third information includes a third bit.

The third bit is used to indicate whether the first device as a whole supports the capability of data collection for the AI/ML purpose.

In some embodiments, the third information is associated with a type of collected data.

In some embodiments, the type of collected data associated with the third information is agreed upon by a protocol, or the type of collected data associated with the third information is indicated by an information field included in the third information.

In some embodiments, the third information includes n₃ groups of sub-information, each group of sub-information in the n₃ groups of sub-information includes one or more bits, each group of the sub-information is associated with a functional unit or a group of functional units inside the first device, and n₃ is a positive integer.

In a case that each group of the sub-information includes one bit, an i^{th} group of sub-information is used to indicate whether a functional unit or a group of functional units, associated with the i^{th} group of sub-information, inside the first device supports the capability of data collection for the AI/ML purpose.

Alternatively, in a case that each group of the sub-information includes at least two bits, each group of the sub-information includes a tenth information field and an eleventh information field. A tenth information field included in an i^{th} group of sub-information is used to indicate whether a functional unit or a group of functional units, associated with the i^{th} group of sub-information, inside the first device supports the capability of data collection for the AI/ML purpose, and an eleventh information field included in the i^{th} group of sub-information is used to indicate a set of types of collected data.

Alternatively, in a case that each group of the sub-information includes at least one bit, each group of the sub-information includes a twelfth information field. A twelfth information field included in an i^{th} group of sub-information is used to indicate whether a functional unit or a group of functional units, associated with the i^{th} group of sub-information, inside the first device supports the capability of data collection for the AI/ML purpose, and indicate a set of types of collected data.

Alternatively, in a case that each group of the sub-information includes at least one bit, an i^{th} group of sub-information is used to indicate a set of types of data collected by a functional unit or a group of functional units, associated with the i^{th} group of sub-information, inside the first device.

Herein i is a positive integer, and 1≤i≤n₃.

In some embodiments, the tenth information field includes one bit, and/or the eleventh information field includes at least one bit.

In some embodiments, each bit of the eleventh information field is associated with a type of or a group of types of collected data, and the value of each bit included in the eleventh information field is used to determine whether the type of or the group of types of collected data associated with the value of respective bit supports being collected by the first device; or
each type of bit status value of the eleventh information field is associated with a type of or a group of types of collected data, and each type of bit status value of the eleventh information field indicates that the type of or the group of types of collected data associated with respective type of bit status value supports being collected by the first device.

In some embodiments, the type of or the group of types of collected data associated with respective bit of the eleventh information field is agreed upon by a protocol, or the type of or the group of types of collected data associated with respective type of bit status value of the eleventh information field is agreed upon by a protocol.

In some embodiments, each group of the sub-information includes a thirteenth information field, and a thirteenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₃ groups of sub-information, inside the first device is agreed upon by a protocol.

In some embodiments, the third information is associated with data collection trigger type indication information.

A bit status value of the data collection trigger type indication information is used to indicate that the first device supports only data collection triggered by the first device, or a bit status value of the data collection trigger type indication information is used to indicate that the first device supports only data collection triggered by the second device, or a bit status value of the data collection trigger type indication information is used to indicate that the first device supports both data collection triggered by the first device and data collection triggered by the second device.

In some embodiments, the data collection trigger type indication information associated with the third information is agreed upon by a protocol, or the data collection trigger type indication information associated with the third information is indicated by an information field in the third information.

In some embodiments, the M pieces of information include fourth information, and the fourth information is used to indicate whether the first device supports the capability of data reporting for the AI/ML purpose.

In some embodiments, the fourth information includes a fourth bit.

The fourth bit is used to indicate whether the first device as a whole supports the capability of data reporting for the AI/ML purpose.

In some embodiments, the fourth information is associated with a type of reported data.

In some embodiments, the type of reported data associated with the fourth information is agreed upon by a protocol, or the type of reported data associated with the fourth information is indicated by an information field included in the fourth information.

In some embodiments, the fourth information includes n₄ groups of sub-information, and each group of sub-information in the n₄ groups of sub-information includes one or more bits. Each group of the sub-information is associated with a functional unit or a group of functional units inside the first device, and n₄ is a positive integer.

In a case that each group of the sub-information includes one bit, an i^{th} group of sub-information is used to indicate whether a functional unit or a group of functional units, associated with the i^{th} group of sub-information, inside the first device supports the capability of data reporting for the AI/ML purpose.

Alternatively, in a case that each group of the sub-information includes at least two bits, each group of the sub-information includes a fourteenth information field and a fifteenth information field. A fourteenth information field included in an i^{th} group of sub-information is used to indicate whether a functional unit or a group of functional units, associated with the i^{th} group of sub-information, inside the first device supports the capability of data reporting for the AI/ML purpose, and a fifteenth information field included in the i^{th} group of sub-information is used to indicate a set of types of reported data.

Alternatively, in a case that each group of the sub-information includes at least one bit, each group of the sub-information includes a sixteenth information field. A sixteenth information field included in an i^{th} group of sub-information is used to indicate whether a functional unit or a group of functional units, associated with the i^{th} group of sub-information, inside the first device supports the capability of data reporting for the AI/ML purpose, and indicate a set of types of reported data.

Alternatively, in a case that each group of the sub-information includes at least one bit, an i^{th} group of sub-information is used to indicate a set of types of data reported by a functional unit or a group of functional units, associated with the i^{th} group of sub-information, inside the first device.

Herein i is a positive integer, and 1≤i≤n₄.

In some embodiments, the fourteenth information field includes one bit, and/or the fifteenth information field includes at least one bit.

In some embodiments, each bit of the fifteenth information field is associated with a type of or a group of types of reported data, and the value of each bit included in the fifteenth information field is used to determine whether the type of or the group of types of reported data associated with the value of respective bit supports being reported by the first device.

Alternatively, each type of bit status value of the fifteenth information field is associated with a type of or a group of types of reported data, and each type of bit status value of the fifteenth information field indicates that the type of or the group of types of reported data associated with respective type of bit status value supports being reported by the first device.

In some embodiments, the type of or the group of types of reported data associated with respective bit of the fifteenth information field is agreed upon by a protocol, or the type of or the group of types of reported data associated with respective type of bit status value of the fifteenth information field is agreed upon by a protocol.

In some embodiments, each group of the sub-information includes a seventeenth information field, and a seventeenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₄ groups of sub-information, inside the first device is agreed upon by a protocol.

In some embodiments, the fourth information is associated with a data reporting trigger type indication information.

A bit status value of the data reporting trigger type indication information is used to indicate that the first device supports only data reporting triggered by the first device, or a bit status value of the data reporting trigger type indication information is used to indicate that the first device supports only data reporting triggered by the second device, or a bit status value of the data reporting trigger type indication information is used to indicate that the first device supports both data reporting triggered by the first device and data reporting triggered by the second device.

In some embodiments, the data reporting trigger type indication information associated with the fourth information is agreed upon by a protocol, or the data reporting trigger type indication information associated with the fourth information is indicated by an information field in the fourth information.

In some embodiments, the M pieces of information include fifth information, and the fifth information is used to indicate whether the first device supports the capability of data measurement for the AI/ML purpose.

In some embodiments, the fifth information includes a fifth bit.

The fifth bit is used to indicate whether the first device as a whole supports the capability of data measurement for the AI/ML purpose.

In some embodiments, the fifth information is associated with a type of measured data.

In some embodiments, the type of measured data associated with the fifth information is agreed upon by a protocol, or the type of measured data associated with the fifth information is indicated by an information field included in the fifth information.

In some embodiments, the fifth information includes n₅ groups of sub-information, and each group of sub-information in the n₅ groups of sub-information includes one or more bits. Each group of the sub-information is associated with a functional unit or a group of functional units inside the first device, and n₅ is a positive integer.

In a case that each group of the sub-information includes one bit, an i^{th} group of sub-information is used to indicate whether a functional unit or a group of functional units, associated with the i^{th} group of sub-information, inside the first device supports the capability of data measurement for the AI/ML purpose.

Alternatively, in a case that each group of the sub-information includes at least two bits, each group of the sub-information includes an eighteenth information field and a nineteenth information field. An eighteenth information field included in an i^{th} group of sub-information is used to indicate whether a functional unit or a group of functional units, associated with the i^{th} group of sub-information, inside the first device supports the capability of data measurement for the AI/ML purpose, and a nineteenth information field included in the i^{th} group of sub-information is used to indicate a set of types of measured data.

Alternatively, in a case that each group of the sub-information includes at least one bit, each group of the sub-information includes a twentieth information field. A twentieth information field included in an i^{th} group of sub-information is used to indicate whether a functional unit or a group of functional units, associated with the i^{th} group of sub-information, inside the first device supports the capability of data measurement for the AI/ML purpose, and indicate a set of types of measured data.

Alternatively, in a case that each group of the sub-information includes at least one bit, an i^{th} group of sub-information is used to indicate a set of types of data measured by a functional unit or a group of functional units, associated with the i^{th} group of sub-information, inside the first device.

Herein i is a positive integer, and 1≤i≤n₅.

In some embodiments, the eighteenth information field includes one bit, and/or the nineteenth information field includes at least one bit.

In some embodiments, each bit of the nineteenth information field is associated with a type of or a group of types of measured data, and the value of each bit included in the nineteenth information field is used to determine whether the type of or the group of types of measured data associated with the value of respective bit supports being measured by the first device; or
each type of bit status value of the nineteenth information field is associated with a type of or a group of types of measured data, and each type of bit status value of the nineteenth information field indicates that the type of or the group of types of measured data associated with respective type of bit status value supports being measured by the first device.

In some embodiments, the type of or the group of types of measured data associated with respective bit of the nineteenth information field is agreed upon by a protocol, or the type of or the group of types of measured data associated with respective type of bit status value of the nineteenth information field is agreed upon by a protocol.

In some embodiments, each group of the sub-information includes a twenty-first information field, and a twenty-first information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₅ groups of sub-information, inside the first device is agreed upon by a protocol.

In some embodiments, the fifth information is associated with data measurement trigger type indication information.

A bit status value of the data measurement trigger type indication information is used to indicate that the first device supports only data measurement triggered by the first device, or a bit status value of the data measurement trigger type indication information is used to indicate that the first device supports only data measurement triggered by the second device, or a bit status value of the data measurement trigger type indication information is used to indicate that the first device supports both data measurement triggered by the first device and data measurement triggered by the second device.

In some embodiments, the data measurement trigger type indication information associated with the fifth information is agreed upon by a protocol, or the data measurement trigger type indication information associated with the fifth information is indicated by an information field in the fifth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the M pieces of information include sixth information, and the sixth information is used to indicate whether the first device supports the capability of offline AI/ML model training.

In some embodiments, the sixth information is associated with offline AI/ML model training type indication information.

A bit status value of the offline AI/ML model training type indication information is used to indicate that the first device supports only offline AI/ML model training triggered by the first device, or a bit status value of the offline AI/ML model training type indication information is used to indicate that the first device supports only offline AI/ML model training triggered by the second device, or a bit status value of the offline AI/ML model training type indication information is used to indicate that the first device supports both offline AI/ML model training triggered by the first device and offline AI/ML model training triggered by the second device.

In some embodiments, the offline AI/ML model training type indication information associated with the sixth information is agreed upon by a protocol, or the offline AI/ML model training type indication information associated with the sixth information is indicated by an information field in the sixth information.

In some embodiments, the M pieces of information include seventh information, and the seventh information is used to indicate whether the first device supports the capability of online AI/ML model training.

In some embodiments, the seventh information is associated with an online AI/ML model training type indication information.

A bit status value of the online AI/ML model training type indication information is used to indicate that the first device supports only online AI/ML model training triggered by the first device, or a bit status value of the online AI/ML model training type indication information is used to indicate that the first device supports only online AI/ML model training triggered by the second device, or a bit status value of the online AI/ML model training type indication information is used to indicate that the first device supports both online AI/ML model training triggered by the first device and online AI/ML model training triggered by the second device.

In some embodiments, the online AI/ML model training type indication information associated with the seventh information is agreed upon by a protocol, or the online AI/ML model training type indication information associated with the seventh information is indicated by an information field in the seventh information.

In some embodiments, the M pieces of information include eighth information, and the eighth information is used to indicate the AI/ML model running or the AI/ML model compiling format supported by the first device.

In some embodiments, the M pieces of information include ninth information, and the ninth information is used to indicate whether the first device supports the reasoning capability of the AI/ML model.

In some embodiments, the ninth information is associated with AI/ML model reasoning type indication information.

A bit status value of the AI/ML model reasoning type indication information is used to indicate that the first device supports only non-federated reasoning or centralized reasoning, or a bit status value of the AI/ML model reasoning type indication information is used to indicate that the first device supports only federated reasoning or distributed reasoning, or a bit status value of the AI/ML model reasoning type indication information is used to indicate that the first device supports federated reasoning and non-federated reasoning.

In some embodiments, the AI/ML model reasoning type indication information associated with the ninth information is agreed upon by a protocol, or the AI/ML model reasoning type indication information associated with the ninth information is indicated by an information field in the ninth information.

In some embodiments, the M pieces of information include tenth information, and the tenth information is used to indicate whether the first device supports the handover capability of the AI/ML model.

In some embodiments, the tenth information is associated with an AI/ML model handover type indication information.

A bit status value of the AI/ML model handover type indication information is used to indicate that the AI/ML model is allowed to be handed over only by the first device, or a bit status value of the AI/ML model handover type indication information is used to indicate that the AI/ML model is allowed to be handed over only by the second device, or a bit status value of the AI/ML model handover type indication information is used to indicate that the AI/ML model is allowed to be handed over by the first device or the second device.

In some embodiments, the AI/ML model handover type indication information associated with the tenth information is agreed upon by a protocol, or the AI/ML model handover type indication information associated with the tenth information is indicated by an information field in the tenth information.

In some embodiments, the M pieces of information include eleventh information, and the eleventh information is used to indicate whether the first device supports the activation capability or the deactivation capability of the AI/ML model.

In some embodiments, the eleventh information is associated with AI/ML model activation/deactivation type indication information.

A bit status value of the AI/ML model activation/deactivation type indication information is used to indicate that the AI/ML model is allowed to be activated or deactivated only by the first device, or a bit status value of the AI/ML model activation/deactivation type indication information is used to indicate that the AI/ML model is allowed to be activated or deactivated only by the second device, or a bit status value of the AI/ML model activation/deactivation type indication information is used to indicate that the AI/ML model is allowed to be activated or deactivated by the first device or the second device.

In some embodiments, the AI/ML model activation/deactivation type indication information associated with the eleventh information is agreed upon by a protocol, or the AI/ML model activation/deactivation type indication information associated with the eleventh information is indicated by an information field in the eleventh information.

In some embodiments, the M pieces of information include twelfth information, and the twelfth information is used to indicate whether the first device supports the performance monitoring capability of the AI/ML model.

In some embodiments, the twelfth information is associated with AI/ML model performance monitoring type indication information.

A bit status value of the AI/ML model performance monitoring type indication information is used to indicate that performance monitoring of the AI/ML model is allowed to be performed only by the first device, or a bit status value of the AI/ML model performance monitoring type indication information is used to indicate that performance monitoring of the AI/ML model is allowed to be performed only by the second device, or a bit status value of the AI/ML model performance monitoring type indication information is used to indicate that performance monitoring of the AI/ML model is allowed to be performed by the first device or the second device.

In some embodiments, the AI/ML model performance monitoring type indication information associated with the twelfth information is agreed upon by a protocol, or the AI/ML model performance monitoring type indication information associated with the twelfth information is indicated by an information field in the twelfth information.

In some embodiments, the M pieces of information include thirteenth information, and the thirteenth information is used to indicate whether the first device supports the transmission capability of the AI/ML model.

In some embodiments, the thirteenth information is associated with an AI/ML model transmission type indication information.

A bit status value of the AI/ML model transmission type indication information is used to indicate that the first device supports only downloading of the AI/ML model, or a bit status value of the AI/ML model transmission type indication information is used to indicate that the first device supports only uploading of the AI/ML model, or a bit status value of the AI/ML model transmission type indication information is used to indicate that the first device supports both downloading of the AI/ML model and uploading of the AI/ML model.

In some embodiments, the AI/ML model transmission type indication information associated with the thirteenth information is agreed upon by a protocol, or the AI/ML model transmission type indication information associated with the thirteenth information is indicated by an information field in the thirteenth information.

In some embodiments, the M pieces of information include fourteenth information, and the fourteenth information is used to indicate whether the first device supports the update capability of the AI/ML model.

In some embodiments, the fourteenth information is associated with AI/ML model update type indication information.

A bit status value of the AI/ML model update type indication information is used to indicate that the AI/ML model is allowed to be updated only by the first device, or a bit status value of the AI/ML model update type indication information is used to indicate that the AI/ML model is allowed to be updated only by the second device, or a bit status value of the AI/ML model update type indication information is used to indicate that the AI/ML model is allowed to be updated by the first device or the second device.

In some embodiments, the AI/ML model update type indication information associated with the fourteenth information is agreed upon by a protocol, or the AI/ML model update type indication information associated with the fourteenth information is indicated by an information field in the fourteenth information.

In some embodiments, a reporting granularity for part of or all of the M pieces of information includes at least one of following: a granularity based on the first device, a granularity based on a functional unit included in the first device, or a granularity based on an identity of the AI/ML model.

In some embodiments, the M pieces of information indicate identity information of M capability sets.

At least part of different content of capability information is included in different capability sets in the M capability sets, or at least part of different types of capability information is included in different capability sets in the M capability sets.

A type of capability information included in j^{th} capability set of the M capability sets includes at least one of following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

Herein j is a positive integer, and 1≤j≤M.

In some embodiments, a type of capability information included in respective capability set in the M capability sets is agreed upon by a protocol, or a type of capability information included in respective capability set in the M capability sets is indicated or configured by a network device.

In some embodiments, the wireless communications device 300 further includes a second communications unit 320.

The second communications unit 320 is configured to receive a second message transmitted by the second device.

The second message includes second AI/ML related capability information, the second AI/ML related capability information is associated with the second device, the second AI/ML related capability information includes S pieces of information, and S is a positive integer.

The S pieces of information are used to indicate at least one of following: whether a functional entity for processing an AI/ML related operation is deployed for the second device, whether the second device supports a capability of on-demand configuration of a functional entity for processing an AI/ML related operation, whether the second device supports a capability of data collection for an AI/ML purpose, whether the second device supports a capability of data reporting for an AI/ML purpose, whether the second device supports a capability of data measurement for an AI/ML purpose, whether the second device supports a capability of offline AI/ML model training, whether the second device supports a capability of online AI/ML model training, AI/ML model running or an AI/ML model compiling format supported by the second device, whether the second device supports a reasoning capability of an AI/ML model, whether the second device supports a handover capability of an AI/ML model, whether the second device supports an activation capability or a deactivation capability of an AI/ML model, whether the second device supports a performance monitoring capability of an AI/ML model, whether the second device supports a transmission capability of an AI/ML model, or whether the second device supports an update capability of an AI/ML model.

In some embodiments, a reporting granularity for part of or all of the S pieces of information includes at least one of following: a granularity based on the second device, a granularity based on a functional unit included in the second device, or a granularity based on an identity of the AI/ML model.

In some embodiments, the transmission capability of the AI/ML model includes a data transmission format of the AI/ML model.

In some embodiments, the first communications unit 310 is further configured to transmit a third message to the second device.

The third message includes a capability update indication information, and the capability update indication information is used to indicate that the first AI/ML related capability information is updated.

In some embodiments, the capability update indication information includes a sixth bit, and the sixth bit is used to indicate that the first AI/ML related capability information is updated; or
the capability update indication information includes a plurality of bits, where each bit of the plurality of bits is associated with a piece of or a group of pieces of AI/ML related capability information, and each bit is used to indicate whether the piece of or the group of pieces of AI/ML related capability information corresponding to respective bit is updated.

In some embodiments, the capability update indication information is triggered based on a preset event, and the preset event is agreed upon by a protocol, or configured by using the second device.

In some embodiments, the second communications unit 320 is further configured to receive a fourth message transmitted by the second device.

The fourth message is used to instruct the first device to report the updated first AI/ML related capability information, or the fourth message is used to instruct the first device to report updated capability information in the first AI/ML related capability information.

In some embodiments, the fourth message includes a capability type indication information, and the capability type indication information is used to indicate a type of the updated capability information reported by the first device.

In some embodiments, the first communications unit 310 is further configured to transmit a fifth message to the second device.

The fifth message includes the updated first AI/ML related capability information, or the fifth message includes updated capability information specified by the second device for reporting.

In some embodiments, the first device is a terminal device, and the second device is a network device.

Alternatively, the first device is a network device, and the second device is a terminal device.

Alternatively, the first device is one terminal device, and the second device is another terminal device.

Alternatively, the first device is one network device, and the second device is another network device.

In some embodiments, in a case that the first device is a terminal device, a functional unit inside the first device includes at least one of the following: a functional entity at a non-access stratum NAS layer, a functional entity at a service data adaptation protocol SDAP layer, a functional entity at a radio resource control RRC layer, a functional entity at a packet data convergence protocol PDCP layer, a functional entity at a radio link control RLC layer, a functional entity at a backhaul adaptation protocol BAP layer, a functional entity at a medium access control MAC layer, or a functional entity at a physical layer PHY layer.

Alternatively, in a case that the first device is an access network device, a functional unit inside the first device includes at least one of the following: a centralized unit CU, a distributed unit DU, a centralized unit control plane CU-CP, a centralized unit user plane CU-UP, a functional entity at a NAS layer, a functional entity at an SDAP layer, a functional entity at an RRC layer, a functional entity at a PDCP layer, a functional entity at an RLC layer, a functional entity at a MAC layer, a functional entity at a PHY layer, or a functional entity at a BAP layer.

Alternatively, in a case that the first device is a core network device, a functional unit inside the first device includes at least one of the following: an access and mobility management function AMF network element, an authentication server function AUSF network element, a user plane function UPF network element, a session management function SMF network element, a location management function LMF network element, a policy control function PCF network element, or a unified data management UDM network element.

In some embodiments, the message is one of the following: a NAS message, an AS message, an interface message, or an AI/ML dedicated message.

In some embodiments, the foregoing communications units may be communications interfaces or transceivers, or input/output interfaces of a communications chip or a system on chip.

It should be understood that the wireless communications device 300 according to embodiments of this application may correspond to the first device in the method embodiments of this application, and the foregoing and other operations and/or functions of the units in the wireless communications device 300 are respectively used to implement corresponding processes of the first device in the method 200 shown in FIG. 2. For brevity, details are not described herein again.

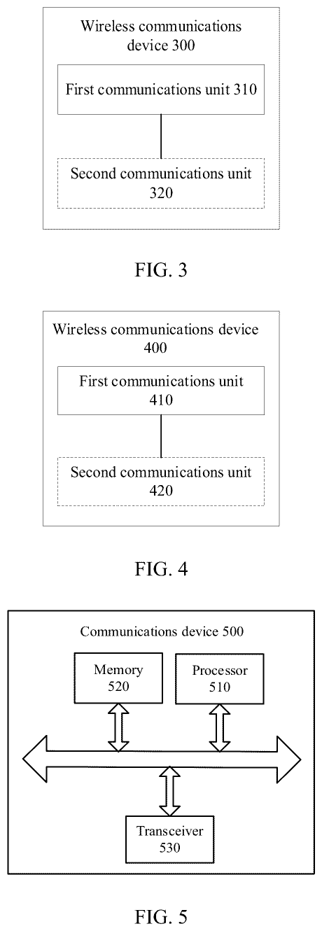

FIG. 4 is a schematic block diagram of a wireless communications device 400 according to an embodiment of this application. The wireless communications device 400 is a second device. As shown in FIG. 4, the wireless communications device 400 includes a first communications unit 410.

The first communications unit 410 is configured to receive a first message transmitted by a first device.

The first message includes first artificial intelligence AI/machine learning ML related capability information, the first AI/ML related capability information is associated with the first device, the first AI/ML related capability information includes M pieces of information, and M is a positive integer.

The M pieces of information are used to indicate at least one of the following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

In some embodiments, the M pieces of information include first information, and the first information is used to indicate whether a functional entity for processing an AI/ML related operation is deployed in the first device.

In some embodiments, the first information includes a first bit.

The first bit is used to indicate whether a functional entity for processing an AI/ML related operation is deployed for the first device as a whole, and part of or all functional units in the first device share a capability indicated by the first bit.

In some embodiments, the first information includes n₁ groups of sub-information, each group of sub-information in the n₁ groups of sub-information includes one or more bits, each group of the sub-information is associated with a functional unit or a group of functional units inside the first device, and n₁ is a positive integer.

In a case that each group of the sub-information includes one bit, an i^{th} group of sub-information is used to indicate whether a functional entity for processing an AI/ML related operation is deployed for a functional unit or a group of functional units, associated with the i^{th} group of sub-information, inside the first device.

Alternatively, in a case that each group of the sub-information includes at least two bits, each group of the sub-information includes a first information field and a second information field, a first information field included in an i^{th} group of sub-information is used to indicate whether a functional entity for processing an AI/ML related operation is deployed for a functional unit or a group of functional units, associated with the i^{th} group of sub-information, inside the first device, and a second information field included in the i^{th} group of sub-information is used to indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, each group of the sub-information includes a third information field, and a third information field included in an i^{th} group of sub-information is used to indicate whether a functional entity for processing an AI/ML related operation is deployed for a functional unit or a group of functional units, associated with the i^{th} group of sub-information, inside the first device, and indicate a type of a functional entity used for processing an AI/ML related operation and deployed in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and deployed in a functional unit or a group of functional units, associated with the i^{th} group of sub-information, inside the first device.

Herein i is a positive integer, and 1≤i≤n₁.

In some embodiments, the first information field includes one bit, and/or the second information field includes at least one bit.

In some embodiments, each group of the sub-information includes a fourth information field, and a fourth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₁ groups of sub-information, inside the first device is agreed upon by a protocol.

In some embodiments, the M pieces of information include second information, and the second information is used to indicate whether the first device supports the capability of on-demand configuration of a functional entity for processing an AI/ML related operation.

In some embodiments, the second information includes a second bit.

The second bit is used to indicate whether the first device supports a capability of on-demand configuration of a functional entity for processing an AI/ML related operation, and part of or all functional units in the first device share the capability indicated by the second bit.

In some embodiments, the second information includes n₂ groups of sub-information, each group of sub-information in the n₂ groups of sub-information includes one or more bits, each group of the sub-information is associated with a functional unit or a group of functional units inside the first device, and n₂ is a positive integer.

In a case that each group of the sub-information includes one bit, an i^{th} group of sub-information is used to indicate whether a functional unit or a group of functional units, associated with the i^{th} group of sub-information, inside the first device supports a capability of on-demand configuration of a functional entity for processing an AI/ML related operation.

Alternatively, in a case that each group of the sub-information includes at least two bits, each group of the sub-information includes a fifth information field and a sixth information field. A fifth information field included in an i^{th} group of sub-information is used to indicate whether a functional unit or a group of functional units, associated with the i^{th} group of sub-information, inside the first device supports a capability of on-demand configuration of a functional entity for processing an AI/ML related operation. A sixth information field included in the i^{th} group of sub-information is used to indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, each group of the sub-information includes a seventh information field. A seventh information field included in an i^{th} group of sub-information is used to indicate whether a functional unit or a group of functional units, associated with the i^{th} group of sub-information, inside the first device supports a capability of on-demand configuration of a functional entity for processing an AI/ML related operation, and indicate a set of types of a functional entity used for processing an AI/ML related operation and configured on demand in the functional unit or the group of functional units, associated with the i^{th} group of sub-information, inside the first device.

Alternatively, in a case that each group of the sub-information includes at least one bit, an i^{th} group of sub-information is used to indicate a type of a functional entity used for processing an AI/ML related operation and configured on demand in a functional unit or a group of functional units, associated with the i^{th} group of sub-information, inside the first device.

Herein i is a positive integer, and 1≤i≤n₂.

In some embodiments, the fifth information field includes one bit, and/or the sixth information field includes at least one bit.

In some embodiments, each bit of the sixth information field is associated with a type of or a group of types of AI/ML functional entities, and the value of each bit included in the sixth information field is used to determine whether the type of or the group of types of AI/ML functional entities associated with the value of respective bit supports on-demand configuration.

Alternatively, each type of bit status value of the sixth information field is associated with a type of or a group of types of AI/ML functional entities, and each type of bit status value of the sixth information field indicates that the type of or the group of types of AI/ML function entities associated with the respective type of bit status value supports on-demand configuration.

In some embodiments, the type of or the group of types of AI/ML function entities associated with respective bit of the sixth information field is agreed upon by a protocol, or the type of or the group of types of AI/ML function entities associated with respective type of bit status value of the sixth information field is agreed upon by a protocol.

In some embodiments, each group of the sub-information includes an eighth information field, and an eighth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₂ groups of sub-information, inside the first device is agreed upon by a protocol.

In some embodiments, the second information is associated with configuration mode information, and the configuration mode information is used to indicate a mode of triggering establishment of an AI/ML functional entity configured on demand.

In some embodiments, the mode of triggering establishment of the AI/ML functional entity configured on demand includes at least one of the following: the first device autonomously triggering establishment of the AI/ML functional entity configured on demand, the second device actively requesting the first device to establish the AI/ML functional entity configured on demand, or the first device establishing the AI/ML functional entity configured on demand after the first device initiates an establishment request and obtains an acknowledgement from the second device.

In some embodiments, the configuration mode information associated with the second information is agreed upon by a protocol.

Alternatively, the second information includes a ninth information field, and the ninth information field is used to indicate the configuration mode information associated with the second information.

In some embodiments, in a case that the ninth information field is used to indicate the configuration mode information associated with the second information, an indication granularity of the ninth information field includes one of the following: a granularity based on the first device, a granularity based on a sub-information group included in the second information, and a granularity based on a type of the AI/ML functional entity configured on demand.

In some embodiments, in a case that the indication granularity of the ninth information field is the granularity based on the first device, configuration modes corresponding to all AI/ML function entities configured on demand and supported by the first device are the same.

Alternatively, in a case that the indication granularity of the ninth information field is the granularity based on a sub-information group included in the second information, configuration modes corresponding to all AI/ML function entities configured on demand and supported by respective sub-information group included in the second information are the same.

Alternatively, in a case that the indication granularity of the ninth information field is the granularity based on a type of the AI/ML functional entity configured on demand, each type of the AI/ML functional entity configured on demand and supported by the second information is independently associated with configuration mode information used to indicate a configuration mode supported by the type of the AI/ML functional entity.

In some embodiments, the type of the functional entity for processing the AI/ML related operation is determined based on a source of an AI/ML related operation capable of being processed, or the type of the functional entity for processing the AI/ML related operation is determined based on a type of an AI/ML related operation capable of being processed.

In some embodiments, in a case that the type of the functional entity for processing the AI/ML related operation is determined based on the source of the AI/ML related operation capable of being processed, the type of the functional entity for processing the AI/ML related operation includes at least one of the following:
an AI/ML functional entity for processing an AI/ML related operation triggered by a functional unit or a group of functional units, associated with an AI/ML functional entity, inside the first device; an AI/ML functional entity for processing an AI/ML related operation triggered by a functional unit other than a functional unit or a group of functional units, associated with an AI/ML functional entity, inside the first device; or an AI/ML functional entity capable of processing both an AI/ML related operation triggered by a functional unit or a group of functional units, associated with an AI/ML functional entity, inside the first device and an AI/ML related operation triggered by a functional unit other than a functional unit or a group of functional units, associated with an AI/ML functional entity, inside the first device.

In some embodiments, in a case that the type of the functional entity for processing the AI/ML related operation is determined based on the type of the AI/ML related operation capable of being processed, different types of AI/ML functional entities support different task sets of AI/ML related operations.

In some embodiments, the AI/ML related operation includes at least one of the following operation tasks: a data management task, a storage management task, a computing power management task, or a model management task.

The data management task includes at least one of following: data collection, data storage, data modification, data update, data deletion, data replication, or data forwarding.

The storage management task includes at least one of the following: remaining storage size indication, storage reservation, storage allocation, storage sharing, storage recycling, or storage formatting.

The computing power management task includes at least one of the following: remaining computing power indication, computing power reservation, computing power allocation, computing power sharing, or computing power recycling.

The model management task includes at least one of the following: model training, model verification, model test, model deployment, model replication, model forwarding, model reasoning, model monitoring, model update, model activation, model deactivation, model deletion, or model handover.

In some embodiments, the M pieces of information include third information, and the third information is used to indicate whether the first device supports the capability of data collection for the AI/ML purpose.

In some embodiments, the third information includes a third bit.

The third bit is used to indicate whether the first device as a whole supports the capability of data collection for the AI/ML purpose.

In some embodiments, the third information is associated with a type of collected data.

In some embodiments, the type of collected data associated with the third information is agreed upon by a protocol, or the type of collected data associated with the third information is indicated by an information field included in the third information.

In some embodiments, the third information includes n₃ groups of sub-information, each group of sub-information in the n₃ groups of sub-information includes one or more bits, each group of the sub-information is associated with a functional unit or a group of functional units inside the first device, and n₃ is a positive integer.

In a case that each group of the sub-information includes one bit, an i^{th} group of sub-information is used to indicate whether a functional unit or a group of functional units, associated with the i^{th} group of sub-information, inside the first device supports the capability of data collection for the AI/ML purpose.

Alternatively, in a case that each group of the sub-information includes at least two bits, each group of the sub-information includes a tenth information field and an eleventh information field. A tenth information field included in an i^{th} group of sub-information is used to indicate whether a functional unit or a group of functional units, associated with the i^{th} group of sub-information, inside the first device supports the capability of data collection for the AI/ML purpose, and an eleventh information field included in the i^{th} group of sub-information is used to indicate a set of types of collected data.

Alternatively, in a case that each group of the sub-information includes at least one bit, each group of the sub-information includes a twelfth information field. A twelfth information field included in an i^{th} group of sub-information is used to indicate whether a functional unit or a group of functional units, associated with the i^{th} group of sub-information, inside the first device supports the capability of data collection for the AI/ML purpose, and indicate a set of types of collected data.

Alternatively, in a case that each group of the sub-information includes at least one bit, an i^{th} group of sub-information is used to indicate a set of types of data collected by a functional unit or a group of functional units, associated with the i^{th} group of sub-information, inside the first device.

Herein i is a positive integer, and 1≤i≤n₃.

In some embodiments, the tenth information field includes one bit, and/or the eleventh information field includes at least one bit.

In some embodiments, each bit of the eleventh information field is associated with a type of or a group of types of collected data, and the value of each bit included in the eleventh information field is used to determine whether the type of or the group of types of collected data associated with the value of respective bit supports being collected by the first device; or
each type of bit status value of the eleventh information field is associated with a type of or a group of types of collected data, and each type of bit status value of the eleventh information field indicates that the type of or the group of types of collected data associated with respective type of bit status value supports being collected by the first device.

In some embodiments, the type of or the group of types of collected data associated with respective bit of the eleventh information field is agreed upon by a protocol, or the type of or the group of types of collected data associated with respective type of bit status value of the eleventh information field is agreed upon by a protocol.

In some embodiments, each group of the sub-information includes a thirteenth information field, and a thirteenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₃ groups of sub-information, inside the first device is agreed upon by a protocol.

In some embodiments, the third information is associated with data collection trigger type indication information.

A bit status value of the data collection trigger type indication information is used to indicate that the first device supports only data collection triggered by the first device, or a bit status value of the data collection trigger type indication information is used to indicate that the first device supports only data collection triggered by the second device, or a bit status value of the data collection trigger type indication information is used to indicate that the first device supports both data collection triggered by the first device and data collection triggered by the second device.

In some embodiments, the data collection trigger type indication information associated with the third information is agreed upon by a protocol, or the data collection trigger type indication information associated with the third information is indicated by an information field in the third information.

In some embodiments, the M pieces of information include fourth information, and the fourth information is used to indicate whether the first device supports the capability of data reporting for the AI/ML purpose.

In some embodiments, the fourth information includes a fourth bit.

The fourth bit is used to indicate whether the first device as a whole supports the capability of data reporting for the AI/ML purpose.

In some embodiments, the fourth information is associated with a type of reported data.

In some embodiments, the type of reported data associated with the fourth information is agreed upon by a protocol, or the type of reported data associated with the fourth information is indicated by an information field included in the fourth information.

In some embodiments, the fourth information includes n₄ groups of sub-information, and each group of sub-information in the n₄ groups of sub-information includes one or more bits. Each group of the sub-information is associated with a functional unit or a group of functional units inside the first device, and n₄ is a positive integer.

In a case that each group of the sub-information includes one bit, an i^{th} group of sub-information is used to indicate whether a functional unit or a group of functional units, associated with the i^{th} group of sub-information, inside the first device supports the capability of data reporting for the AI/ML purpose.

Alternatively, in a case that each group of the sub-information includes at least two bits, each group of the sub-information includes a fourteenth information field and a fifteenth information field. A fourteenth information field included in an i^{th} group of sub-information is used to indicate whether a functional unit or a group of functional units, associated with the i^{th} group of sub-information, inside the first device supports the capability of data reporting for the AI/ML purpose, and a fifteenth information field included in the i^{th} group of sub-information is used to indicate a set of types of reported data.

Alternatively, in a case that each group of the sub-information includes at least one bit, each group of the sub-information includes a sixteenth information field. A sixteenth information field included in an i^{th} group of sub-information is used to indicate whether a functional unit or a group of functional units, associated with the i^{th} group of sub-information, inside the first device supports the capability of data reporting for the AI/ML purpose, and indicate a set of types of reported data.

Alternatively, in a case that each group of the sub-information includes at least one bit, an i^{th} group of sub-information is used to indicate a set of types of data reported by a functional unit or a group of functional units, associated with the i^{th} group of sub-information, inside the first device.

Herein i is a positive integer, and 1≤i≤n₄.

In some embodiments, the fourteenth information field includes one bit, and/or the fifteenth information field includes at least one bit.

In some embodiments, each bit of the fifteenth information field is associated with a type of or a group of types of reported data, and the value of each bit included in the fifteenth information field is used to determine whether the type of or the group of types of reported data associated with the value of respective bit supports being reported by the first device.

Alternatively, each type of bit status value of the fifteenth information field is associated with a type of or a group of types of reported data, and each type of bit status value of the fifteenth information field indicates that the type of or the group of types of reported data associated with respective type of bit status value supports being reported by the first device.

In some embodiments, the type of or the group of types of reported data associated with respective bit of the fifteenth information field is agreed upon by a protocol, or the type of or the group of types of reported data associated with respective type of bit status value of the fifteenth information field is agreed upon by a protocol.

In some embodiments, each group of the sub-information includes a seventeenth information field, and a seventeenth information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₄ groups of sub-information, inside the first device is agreed upon by a protocol.

In some embodiments, the fourth information is associated with a data reporting trigger type indication information.

A bit status value of the data reporting trigger type indication information is used to indicate that the first device supports only data reporting triggered by the first device, or a bit status value of the data reporting trigger type indication information is used to indicate that the first device supports only data reporting triggered by the second device, or a bit status value of the data reporting trigger type indication information is used to indicate that the first device supports both data reporting triggered by the first device and data reporting triggered by the second device.

In some embodiments, the data reporting trigger type indication information associated with the fourth information is agreed upon by a protocol, or the data reporting trigger type indication information associated with the fourth information is indicated by an information field in the fourth information.

In some embodiments, the M pieces of information include fifth information, and the fifth information is used to indicate whether the first device supports the capability of data measurement for the AI/ML purpose.

In some embodiments, the fifth information includes a fifth bit.

The fifth bit is used to indicate whether the first device as a whole supports the capability of data measurement for the AI/ML purpose.

In some embodiments, the fifth information is associated with a type of measured data.

In some embodiments, the type of measured data associated with the fifth information is agreed upon by a protocol, or the type of measured data associated with the fifth information is indicated by an information field included in the fifth information.

In some embodiments, the fifth information includes n₅ groups of sub-information, and each group of sub-information in the n₅ groups of sub-information includes one or more bits. Each group of the sub-information is associated with a functional unit or a group of functional units inside the first device, and n₅ is a positive integer.

In a case that each group of the sub-information includes one bit, an i^{th} group of sub-information is used to indicate whether a functional unit or a group of functional units, associated with the i^{th} group of sub-information, inside the first device supports the capability of data measurement for the AI/ML purpose.

Alternatively, in a case that each group of the sub-information includes at least two bits, each group of the sub-information includes an eighteenth information field and a nineteenth information field. An eighteenth information field included in an i^{th} group of sub-information is used to indicate whether a functional unit or a group of functional units, associated with the i^{th} group of sub-information, inside the first device supports the capability of data measurement for the AI/ML purpose, and a nineteenth information field included in the i^{th} group of sub-information is used to indicate a set of types of measured data.

Alternatively, in a case that each group of the sub-information includes at least one bit, each group of the sub-information includes a twentieth information field. A twentieth information field included in an i^{th} group of sub-information is used to indicate whether a functional unit or a group of functional units, associated with the i^{th} group of sub-information, inside the first device supports the capability of data measurement for the AI/ML purpose, and indicate a set of types of measured data.

Alternatively, in a case that each group of the sub-information includes at least one bit, an i^{th} group of sub-information is used to indicate a set of types of data measured by a functional unit or a group of functional units, associated with the i^{th} group of sub-information, inside the first device.

Herein i is a positive integer, and 1≤i≤n₅.

In some embodiments, the eighteenth information field includes one bit, and/or the nineteenth information field includes at least one bit.

In some embodiments, each bit of the nineteenth information field is associated with a type of or a group of types of measured data, and the value of each bit included in the nineteenth information field is used to determine whether the type of or the group of types of measured data associated with the value of respective bit supports being measured by the first device; or each type of bit status value of the nineteenth information field is associated with a type of or a group of types of measured data, and each type of bit status value of the nineteenth information field indicates that the type of or the group of types of measured data associated with respective type of bit status value supports being measured by the first device.

In some embodiments, the type of or the group of types of measured data associated with respective bit of the nineteenth information field is agreed upon by a protocol, or the type of or the group of types of measured data associated with respective type of bit status value of the nineteenth information field is agreed upon by a protocol.

In some embodiments, each group of the sub-information includes a twenty-first information field, and a twenty-first information field included in the i^{th} group of sub-information is used to indicate the functional unit or the group of functional units, associated with the i^{th} group of sub-information, inside the first device.

In some embodiments, the functional unit or the group of functional units, associated with respective group of sub-information in the n₅ groups of sub-information, inside the first device is agreed upon by a protocol.

In some embodiments, the fifth information is associated with data measurement trigger type indication information.

A bit status value of the data measurement trigger type indication information is used to indicate that the first device supports only data measurement triggered by the first device, or a bit status value of the data measurement trigger type indication information is used to indicate that the first device supports only data measurement triggered by the second device, or a bit status value of the data measurement trigger type indication information is used to indicate that the first device supports both data measurement triggered by the first device and data measurement triggered by the second device.

In some embodiments, the data measurement trigger type indication information associated with the fifth information is agreed upon by a protocol, or the data measurement trigger type indication information associated with the fifth information is indicated by an information field in the fifth information.

In some embodiments, the type of data includes at least one of the following: AI/ML model input data, AI/ML model output data, AI/ML model input data auxiliary pre-processing data, AI/ML model output data auxiliary post-processing data, AI/ML model training data, AI/ML model reasoning data, or AI/ML model performance monitoring data.

In some embodiments, the M pieces of information include sixth information, and the sixth information is used to indicate whether the first device supports the capability of offline AI/ML model training.

In some embodiments, the sixth information is associated with offline AI/ML model training type indication information.

A bit status value of the offline AI/ML model training type indication information is used to indicate that the first device supports only offline AI/ML model training triggered by the first device, or a bit status value of the offline AI/ML model training type indication information is used to indicate that the first device supports only offline AI/ML model training triggered by the second device, or a bit status value of the offline AI/ML model training type indication information is used to indicate that the first device supports both offline AI/ML model training triggered by the first device and offline AI/ML model training triggered by the second device.

In some embodiments, the offline AI/ML model training type indication information associated with the sixth information is agreed upon by a protocol, or the offline AI/ML model training type indication information associated with the sixth information is indicated by an information field in the sixth information.

In some embodiments, the M pieces of information include seventh information, and the seventh information is used to indicate whether the first device supports the capability of online AI/ML model training.

In some embodiments, the seventh information is associated with an online AI/ML model training type indication information.

A bit status value of the online AI/ML model training type indication information is used to indicate that the first device supports only online AI/ML model training triggered by the first device, or a bit status value of the online AI/ML model training type indication information is used to indicate that the first device supports only online AI/ML model training triggered by the second device, or a bit status value of the online AI/ML model training type indication information is used to indicate that the first device supports both online AI/ML model training triggered by the first device and online AI/ML model training triggered by the second device.

In some embodiments, the online AI/ML model training type indication information associated with the seventh information is agreed upon by a protocol, or the online AI/ML model training type indication information associated with the seventh information is indicated by an information field in the seventh information.

In some embodiments, the M pieces of information include eighth information, and the eighth information is used to indicate the AI/ML model running or the AI/ML model compiling format supported by the first device.

In some embodiments, the M pieces of information include ninth information, and the ninth information is used to indicate whether the first device supports the reasoning capability of the AI/ML model.

In some embodiments, the ninth information is associated with AI/ML model reasoning type indication information.

A bit status value of the AI/ML model reasoning type indication information is used to indicate that the first device supports only non-federated reasoning or centralized reasoning, or a bit status value of the AI/ML model reasoning type indication information is used to indicate that the first device supports only federated reasoning or distributed reasoning, or a bit status value of the AI/ML model reasoning type indication information is used to indicate that the first device supports federated reasoning and non-federated reasoning.

In some embodiments, the AI/ML model reasoning type indication information associated with the ninth information is agreed upon by a protocol, or the AI/ML model reasoning type indication information associated with the ninth information is indicated by an information field in the ninth information.

In some embodiments, the M pieces of information include tenth information, and the tenth information is used to indicate whether the first device supports the handover capability of the AI/ML model.

In some embodiments, the tenth information is associated with an AI/ML model handover type indication information.

A bit status value of the AI/ML model handover type indication information is used to indicate that the AI/ML model is allowed to be handed over only by the first device, or a bit status value of the AI/ML model handover type indication information is used to indicate that the AI/ML model is allowed to be handed over only by the second device, or a bit status value of the AI/ML model handover type indication information is used to indicate that the AI/ML model is allowed to be handed over by the first device or the second device.

In some embodiments, the AI/ML model handover type indication information associated with the tenth information is agreed upon by a protocol, or the AI/ML model handover type indication information associated with the tenth information is indicated by an information field in the tenth information.

In some embodiments, the M pieces of information include eleventh information, and the eleventh information is used to indicate whether the first device supports the activation capability or the deactivation capability of the AI/ML model.

In some embodiments, the eleventh information is associated with AI/ML model activation/deactivation type indication information.

A bit status value of the AI/ML model activation/deactivation type indication information is used to indicate that the AI/ML model is allowed to be activated or deactivated only by the first device, or a bit status value of the AI/ML model activation/deactivation type indication information is used to indicate that the AI/ML model is allowed to be activated or deactivated only by the second device, or a bit status value of the AI/ML model activation/deactivation type indication information is used to indicate that the AI/ML model is allowed to be activated or deactivated by the first device or the second device.

In some embodiments, the AI/ML model activation/deactivation type indication information associated with the eleventh information is agreed upon by a protocol, or the AI/ML model activation/deactivation type indication information associated with the eleventh information is indicated by an information field in the eleventh information.

In some embodiments, the M pieces of information include twelfth information, and the twelfth information is used to indicate whether the first device supports the performance monitoring capability of the AI/ML model.

In some embodiments, the twelfth information is associated with AI/ML model performance monitoring type indication information.

A bit status value of the AI/ML model performance monitoring type indication information is used to indicate that performance monitoring of the AI/ML model is allowed to be performed only by the first device, or a bit status value of the AI/ML model performance monitoring type indication information is used to indicate that performance monitoring of the AI/ML model is allowed to be performed only by the second device, or a bit status value of the AI/ML model performance monitoring type indication information is used to indicate that performance monitoring of the AI/ML model is allowed to be performed by the first device or the second device.

In some embodiments, the AI/ML model performance monitoring type indication information associated with the twelfth information is agreed upon by a protocol, or the AI/ML model performance monitoring type indication information associated with the twelfth information is indicated by an information field in the twelfth information.

In some embodiments, the M pieces of information include thirteenth information, and the thirteenth information is used to indicate whether the first device supports the transmission capability of the AI/ML model.

In some embodiments, the thirteenth information is associated with an AI/ML model transmission type indication information.

A bit status value of the AI/ML model transmission type indication information is used to indicate that the first device supports only downloading of the AI/ML model, or a bit status value of the AI/ML model transmission type indication information is used to indicate that the first device supports only uploading of the AI/ML model, or a bit status value of the AI/ML model transmission type indication information is used to indicate that the first device supports both downloading of the AI/ML model and uploading of the AI/ML model.

In some embodiments, the AI/ML model transmission type indication information associated with the thirteenth information is agreed upon by a protocol, or the AI/ML model transmission type indication information associated with the thirteenth information is indicated by an information field in the thirteenth information.

In some embodiments, the M pieces of information include fourteenth information, and the fourteenth information is used to indicate whether the first device supports the update capability of the AI/ML model.

In some embodiments, the fourteenth information is associated with AI/ML model update type indication information.

A bit status value of the AI/ML model update type indication information is used to indicate that the AI/ML model is allowed to be updated only by the first device, or a bit status value of the AI/ML model update type indication information is used to indicate that the AI/ML model is allowed to be updated only by the second device, or a bit status value of the AI/ML model update type indication information is used to indicate that the AI/ML model is allowed to be updated by the first device or the second device.

In some embodiments, the AI/ML model update type indication information associated with the fourteenth information is agreed upon by a protocol, or the AI/ML model update type indication information associated with the fourteenth information is indicated by an information field in the fourteenth information.

In some embodiments, a reporting granularity for part of or all of the M pieces of information includes at least one of following: a granularity based on the first device, a granularity based on a functional unit included in the first device, or a granularity based on an identity of the AI/ML model.

In some embodiments, the M pieces of information indicate identity information of M capability sets.

At least part of different content of capability information is included in different capability sets in the M capability sets, or at least part of different types of capability information is included in different capability sets in the M capability sets.

A type of capability information included in j^{th} capability set of the M capability sets includes at least one of following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

Herein j is a positive integer, and 1≤j≤M.

In some embodiments, a type of capability information included in respective capability set in the M capability sets is agreed upon by a protocol, or a type of capability information included in respective capability set in the M capability sets is indicated or configured by a network device.

In some embodiments, the wireless communications device 400 further includes a second communications unit 420.

The second communications unit 420 is configured to transmit a second message to the first device.

The second message includes second AI/ML related capability information, the second AI/ML related capability information is associated with the second device, the second AI/ML related capability information includes S pieces of information, and S is a positive integer.

The S pieces of information are used to indicate at least one of following: whether a functional entity for processing an AI/ML related operation is deployed for the second device, whether the second device supports a capability of on-demand configuration of a functional entity for processing an AI/ML related operation, whether the second device supports a capability of data collection for an AI/ML purpose, whether the second device supports a capability of data reporting for an AI/ML purpose, whether the second device supports a capability of data measurement for an AI/ML purpose, whether the second device supports a capability of offline AI/ML model training, whether the second device supports a capability of online AI/ML model training, AI/ML model running or an AI/ML model compiling format supported by the second device, whether the second device supports a reasoning capability of an AI/ML model, whether the second device supports a handover capability of an AI/ML model, whether the second device supports an activation capability or a deactivation capability of an AI/ML model, whether the second device supports a performance monitoring capability of an AI/ML model, whether the second device supports a transmission capability of an AI/ML model, or whether the second device supports an update capability of an AI/ML model.

In some embodiments, a reporting granularity for part of or all of the S pieces of information includes at least one of following: a granularity based on the second device, a granularity based on a functional unit included in the second device, or a granularity based on an identity of the AI/ML model.

In some embodiments, the transmission capability of the AI/ML model includes a data transmission format of the AI/ML model.

In some embodiments, the first communications unit 410 is further configured to receive a third message transmitted by the first device.

The third message includes a capability update indication information, and the capability update indication information is used to indicate that the first AI/ML related capability information is updated.

In some embodiments, the capability update indication information includes a sixth bit, and the sixth bit is used to indicate that the first AI/ML related capability information is updated.

Alternatively, the capability update indication information includes a plurality of bits, where each bit of the plurality of bits is associated with a piece of or a group of pieces of AI/ML related capability information, and each bit is used to indicate whether the piece of or the group of pieces of AI/ML related capability information corresponding to respective bit is updated.

In some embodiments, the second communications unit 420 is further configured to transmit a fourth message to the first device.

The fourth message is used to instruct the first device to report the updated first AI/ML related capability information, or the fourth message is used to instruct the first device to report updated capability information in the first AI/ML related capability information.

In some embodiments, the fourth message includes a capability type indication information, and the capability type indication information is used to indicate a type of the updated capability information reported by the first device.

In some embodiments, the first communications unit 410 is further configured to receive a fifth message transmitted by the first device.

The fifth message includes the updated first AI/ML related capability information, or the fifth message includes updated capability information specified by the second device for reporting.

In some embodiments, the first device is a terminal device, and the second device is a network device.

Alternatively, the first device is a network device, and the second device is a terminal device.

Alternatively, the first device is one terminal device, and the second device is another terminal device.

Alternatively, the first device is one network device, and the second device is another network device.

In some embodiments, in a case that the first device is a terminal device, a functional unit inside the first device includes at least one of the following: a functional entity at a non-access stratum NAS layer, a functional entity at a service data adaptation protocol SDAP layer, a functional entity at a radio resource control RRC layer, a functional entity at a packet data convergence protocol PDCP layer, a functional entity at a radio link control RLC layer, a functional entity at a backhaul adaptation protocol BAP layer, a functional entity at a medium access control MAC layer, or a functional entity at a physical layer PHY layer.

Alternatively, in a case that the first device is an access network device, a functional unit inside the first device includes at least one of the following: a centralized unit CU, a distributed unit DU, a centralized unit control plane CU-CP, a centralized unit user plane CU-UP, a functional entity at a NAS layer, a functional entity at an SDAP layer, a functional entity at an RRC layer, a functional entity at a PDCP layer, a functional entity at an RLC layer, a functional entity at a MAC layer, a functional entity at a PHY layer, or a functional entity at a BAP layer.

Alternatively, in a case that the first device is a core network device, a functional unit inside the first device includes at least one of the following: an access and mobility management function AMF network element, an authentication server function AUSF network element, a user plane function UPF network element, a session management function SMF network element, a location management function LMF network element, a policy control function PCF network element, or a unified data management UDM network element.

In some embodiments, the message is one of the following: a NAS message, an AS message, an interface message, or an AI/ML dedicated message.

In some embodiments, the foregoing communications units may be communications interfaces or transceivers, or input/output interfaces of a communications chip or a system on chip.

It should be understood that the wireless communications device 400 according to embodiments of this application may correspond to the second device in the method embodiments of this application, and the foregoing and other operations and/or functions of the units in the wireless communications device 400 are respectively used to implement corresponding processes of the second device in the method 200 shown in FIG. 2. For brevity, details are not described herein again.

FIG. 5 is a schematic structural diagram of a communications device 500 according to an embodiment of this application. The communications device 500 shown in FIG. 5 includes a processor 510, and the processor 510 may invoke a computer program from a memory and run the computer program to implement a method in embodiments of this application.

In some embodiments, as shown in FIG. 5, the communications device 500 may further include a memory 520. The processor 510 may invoke a computer program from the memory 520 and run the computer program to implement a method in embodiments of this application.

The memory 520 may be a separate component independent of the processor 510, or may be integrated into the processor 510.

In some embodiments, as shown in FIG. 5, the communications device 500 may further include a transceiver 530. The processor 510 may control the transceiver 530 to communicate with another device. Specifically, the processor 510 may transmit information or data to the another device, or receive information or data transmitted by the another device.

The transceiver 530 may include a transmitter and a receiver. The transceiver 530 may further include an antenna, and a quantity of antennas may be one or more.

In some embodiments, the processor 510 may implement a function of a processing unit in the first device, or the processor 510 may implement a function of a processing unit in the second device. For brevity, details are not described herein again.

In some embodiments, the transceiver 530 may implement a function of a communications unit in the first device. For brevity, details are not described herein again.

In some embodiments, the transceiver 530 may implement a function of a communications unit in the second device. For brevity, details are not described herein again.

In some embodiments, the communications device 500 may be specifically the first device in embodiments of this application, and the communications device 500 may implement corresponding processes implemented by the first device in methods in embodiments of this application. For brevity, details are not described herein again.

In some embodiments, the communications device 500 may be specifically the second device in embodiments of this application, and the communications device 500 may implement corresponding processes implemented by the second device in methods in embodiments of this application. For brevity, details are not described herein again.

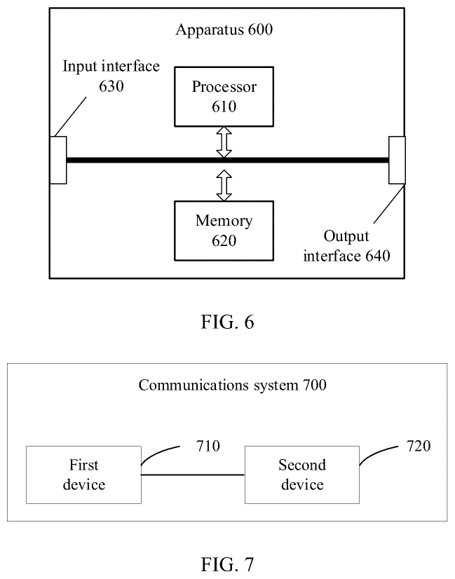

FIG. 6 is a schematic structural diagram of an apparatus according to an embodiment of the present application. The apparatus 600 shown in FIG. 6 includes a processor 610, and the processor 610 may invoke a computer program from a memory and run the computer program to implement a method in embodiments of this application.

In some embodiments, as shown in FIG. 6, the apparatus 600 may further include a memory 620. The processor 610 may invoke a computer program from the memory 620 and run the computer program to implement a method in embodiments of this application.

The memory 620 may be a separate component independent of the processor 610, or may be integrated into the processor 610.

In some embodiments, the apparatus 600 may further include an input interface 630. The processor 610 may control the input interface 630 to communicate with another device or chip, and specifically, may acquire information or data transmitted by the another device or chip. In at least one embodiment, the processor 610 may be on or off a chip.

In some embodiments, the processor 610 may implement a function of a processing unit in the first device, or the processor 610 may implement a function of a processing unit in the second device. For brevity, details are not described herein again.

In some embodiments, the input interface 630 may implement a function of a communications unit in the first device, or the input interface 630 may implement a function of a communications unit in the second device.

In some embodiments, the apparatus 600 may further include an output interface 640. The processor 610 may control the output interface 640 to communicate with another device or chip, and specifically, may output information or data to the another device or chip. In at least one embodiment, the processor 610 may be on or off a chip.

In some embodiments, the output interface 640 may implement a function of a communications unit in the first device, or the output interface 640 may implement a function of a communications unit in the second device.

In some embodiments, the apparatus may be applied to the first device in embodiments of this application, and the apparatus may implement corresponding processes implemented by the first device in methods in embodiments of this application. For brevity, details are not described herein again.

In some embodiments, the apparatus may be applied to the second device in embodiments of this application, and the apparatus may implement corresponding processes implemented by the second device in methods in embodiments of this application. For brevity, details are not described herein again.

In some embodiments, the apparatus mentioned in embodiments of this application may alternatively be a chip, for example, may be a system-level chip, a system chip, a chip system, or a system-on-chip, or the like.

FIG. 7 is a schematic block diagram of a communications system 700 according to an embodiment of this application. As shown in FIG. 7, the communications system 700 includes a first device 710 and a second device 720.

The first device 710 may be used to implement the corresponding functions implemented by the first device in the foregoing methods, and the second device 720 may be used to implement the corresponding functions implemented by the second device in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an electrically erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct Rambus random access memory (DR RAM), or the like. In other words, the memory in this embodiment of this application includes but is not limited to these memories and any memory of another proper type.

An embodiment of this application further provides a computer-readable storage medium, configured to store a computer program.

In some embodiments, the computer-readable storage medium may be applied to the first device in the embodiments of this application, and the computer program causes a computer to execute corresponding processes implemented by the first device in methods in the embodiments of this application. For brevity, details are not described herein again.

In some embodiments, the computer-readable storage medium may be applied to the second device in the embodiments of this application, and the computer program causes a computer to execute corresponding processes implemented by the second device in methods in the embodiments of this application. For brevity, details are not described herein again.

An embodiment of this application further provides a computer program product, including computer program instructions.

In some embodiments, the computer program product may be applied to the first device in the embodiments of this application, and the computer program instructions cause a computer to execute corresponding processes implemented by the first device in methods in the embodiments of this application. For brevity, details are not described herein again.

In some embodiments, the computer program product may be applied to the second device in the embodiments of this application, and the computer program instructions cause a computer to execute corresponding processes implemented by the second device in methods in the embodiments of this application. For brevity, details are not described herein again.

An embodiment of this application further provides a computer program.

In some embodiments, the computer program may be applied to the first device in the embodiments of this application. When the computer program runs on a computer, the computer executes corresponding processes implemented by the first device in methods in the embodiments of this application. For brevity, details are not described herein again.

In some embodiments, the computer program may be applied to the second device in the embodiments of this application. When the computer program runs on a computer, the computer executes corresponding processes implemented by the second device in methods in the embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each specific application, but it should not be considered that the implementation goes beyond the scope of this application.

It may be clearly understood by a person skilled in the art that, for the purpose of convenient and brief description, for a detailed working process of the foregoing system, apparatus, and unit, reference may be made to corresponding processes in the foregoing method embodiments, and details are not described herein again.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. For such understanding, the essence of the technical solutions of this application or the part contributing to the prior art, or some of the technical solutions may be represented in the form of software products. The computer software products are stored in a storage medium, and include a number of instructions to enable a computer device (which may be a personal computer, a server, a network device, or the like) to perform all or some of the steps of the methods described in various embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A communications device, wherein the communications device is a first device, the first device comprises a processor and a memory, the memory is configured to store a computer program, and the processor is configured to invoke the computer program stored from the memory and run the computer program, to cause the first device to perform following operation:
transmitting a first message to a second device,
wherein the first message comprises first artificial intelligence AI/machine learning ML related capability information, the first AI/ML related capability information is associated with the first device, the first AI/ML related capability information comprises M pieces of information, and M is a positive integer; and
the M pieces of information are used to indicate at least one of following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/ML purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

2. The communications device according to claim 1, wherein
the M pieces of information comprise first information, and the first information is used to indicate whether a functional entity for processing an AI/ML related operation is deployed for the first device, wherein the first information comprises:
a first bit, wherein the first bit is used to indicate whether a functional entity for processing an AI/ML related operation is deployed for the first device as a whole, and part of or all functional units in the first device share a capability indicated by the first bit; or
n₁ groups of sub-information, wherein each group of sub-information in the n₁ groups of sub-information comprises one or more bits, each group of the sub-information is associated with a functional unit or a group of functional units inside the first device, and n₁ is a positive integer, wherein
in a case that each group of the sub-information comprises one bit, an i^{th} group of sub-information is used to indicate whether a functional entity for processing an AI/ML related operation is deployed for a functional unit or a group of functional units, associated with the i^{th} group of sub-information, inside the first device; or
in a case that each group of the sub-information comprises at least two bits, each group of the sub-information comprises a first information field and a second information field, a first information field comprised in an i^{th} group of sub-information is used to indicate whether a functional entity for processing an AI/ML related operation is deployed for a functional unit or a group of functional units, associated with the i^{th} group of sub-information, inside the first device, and a second information field comprised in the i^{th} group of sub-information is used to indicate a type of a functional entity used for processing an AI/ML related operation and deployed in the functional unit or the group of functional units, associated with the i^{th} group of sub-information, inside the first device; or
in a case that each group of the sub-information comprises at least one bit, each group of the sub-information comprises a third information field, and a third information field comprised in an i^{th} group of sub-information is used to indicate whether a functional entity for processing an AI/ML related operation is deployed for a functional unit or a group of functional units, associated with the i^{th} group of sub-information, inside the first device, and indicate a type of a functional entity used for processing an AI/ML related operation and deployed in the functional unit or the group of functional units, associated with the i^{th} group of sub-information, inside the first device; or
in a case that each group of the sub-information comprises at least one bit, an i^{th} group of sub-information is used to indicate a type of a functional entity used for processing an AI/ML related operation and deployed in a functional unit or a group of functional units, associated with the i^{th} group of sub-information, inside the first device;
wherein i is a positive integer, 1≤i≤n₁,
each group of the sub-information comprises a fourth information field, and a fourth information field comprised in the i^{th} group of sub-information is used to indicate the functional unit or the group of functional units, associated with the i^{th} group of sub-information, inside the first device; or the functional unit or the group of functional units, associated with respective group of sub-information in the n₁ groups of sub-information, inside the first device is agreed upon by a protocol.

3. The communications device according to claim 1, wherein
the M pieces of information comprise second information, and the second information is used to indicate whether the first device supports a capability of on-demand configuration of a functional entity for processing an AI/ML related operation, wherein the second information comprises:
a second bit, wherein the second bit is used to indicate whether the first device supports a capability of on-demand configuration of a functional entity for processing an AI/ML related operation, and part of or all functional units in the first device share the capability indicated by the second bit; or
n₂ groups of sub-information, wherein each group of sub-information in the n₂ groups of sub-information comprises one or more bits, each group of the sub-information is associated with a functional unit or a group of functional units inside the first device, and n₂ is a positive integer, wherein
in a case that each group of the sub-information comprises one bit, an i^{th} group of sub-information is used to indicate whether a functional unit or a group of functional units, associated with the i^{th} group of sub-information, inside the first device supports a capability of on-demand configuration of a functional entity for processing an AI/ML related operation; or
in a case that each group of the sub-information comprises at least two bits, each group of the sub-information comprises a fifth information field and a sixth information field, a fifth information field comprised in an i^{th} group of sub-information is used to indicate whether a functional unit or a group of functional units, associated with the i^{th} group of sub-information, inside the first device supports a capability of on-demand configuration of a functional entity for processing an AI/ML related operation, and a sixth information field comprised in the i^{th} group of sub-information is used to indicate a set of types of a functional entity used for processing an AI/ML related operation and configured on demand in the functional unit or the group of functional units, associated with the i^{th} group of sub-information, inside the first device; or
in a case that each group of the sub-information comprises at least one bit, each group of the sub-information comprises a seventh information field, and a seventh information field comprised in an i^{th} group of sub-information is used to indicate whether a functional unit or a group of functional units, associated with the i^{th} group of sub-information, inside the first device supports a capability of on-demand configuration of a functional entity for processing an AI/ML related operation, and indicate a set of types of a functional entity used for processing an AI/ML related operation and configured on demand in the functional unit or the group of functional units, associated with the i^{th} group of sub-information, inside the first device; or
in a case that each group of the sub-information comprises at least one bit, an i^{th} group of sub-information is used to indicate a type of a functional entity used for processing an AI/ML related operation and configured on demand in a functional unit or a group of functional units, associated with the i^{th} group of sub-information, inside the first device;
wherein i is a positive integer, 1≤i≤n₂,
each bit of the sixth information field is associated with a type of or a group of types of AI/ML functional entities, and the value of each bit comprised in the sixth information field is used to determine whether the type of or the group of types of AI/ML functional entities associated with the value of respective bit supports on-demand configuration; or each type of bit status value of the sixth information field is associated with a type of or a group of types of AI/ML functional entities, and each type of bit status value of the sixth information field indicates that the type of or the group of types of A l/M L function entities associated with the respective type of bit status value supports on-demand configuration;
the type of or the group of types of AI/ML function entities associated with respective bit of the sixth information field is agreed upon by a protocol, or the type of or the group of types of AI/ML function entities associated with respective type of bit status value of the sixth information field is agreed upon by a protocol; and
each group of the sub-information comprises an eighth information field, and an eighth information field comprised in the i^{th} group of sub-information is used to indicate the functional unit or the group of functional units, associated with the i^{th} group of sub-information, inside the first device; or a functional unit or a group of functional units, associated with respective group of sub-information in the n₂ groups of sub-information, inside the first device is agreed upon by a protocol.

4. The communications device according to claim 3, wherein
the second information is associated with configuration mode information, and the configuration mode information is used to indicate a mode of triggering establishment of an AI/M L functional entity configured on demand;
the mode of triggering establishment of the AI/ML functional entity configured on demand comprises at least one of following: the first device autonomously triggering establishment of the AI/ML functional entity configured on demand, the second device actively requesting the first device to establish the AI/ML functional entity configured on demand, or the first device establishing the AI/ML functional entity configured on demand after the first device initiates an establishment request and obtains an acknowledgement from the second device;
the configuration mode information associated with the second information is agreed upon by a protocol; or the second information comprises a ninth information field, and the ninth information field is used to indicate the configuration mode information associated with the second information; and
in a case that the ninth information field is used to indicate the configuration mode information associated with the second information, an indication granularity of the ninth information field comprises one of following: a granularity based on the first device, a granularity based on a sub-information group comprised in the second information, and a granularity based on a type of the AI/ML functional entity configured on demand, wherein
in a case that the indication granularity of the ninth information field is the granularity based on the first device, configuration modes corresponding to all AI/ML function entities configured on demand and supported by the first device are the same; or
in a case that the indication granularity of the ninth information field is the granularity based on a sub-information group comprised in the second information, configuration modes corresponding to all AI/ML function entities configured on demand and supported by respective sub-information group comprised in the second information are the same; or
in a case that the indication granularity of the ninth information field is the granularity based on a type of the AI/ML functional entity configured on demand, each type of the AI/ML functional entity configured on demand and supported by the second information is independently associated with configuration mode information used to indicate a configuration mode supported by the type of the AI/ML functional entity.

5. The communications device according to claim 2, wherein the type of the functional entity for processing the AI/ML related operation is determined based on a source of an AI/ML related operation capable of being processed, or the type of the functional entity for processing the AI/ML related operation is determined based on a type of an AI/ML related operation capable of being processed, wherein
in a case that the type of the functional entity for processing the AI/ML related operation is determined based on the source of the AI/ML related operation capable of being processed, the type of the functional entity for processing the AI/ML related operation comprises at least one of following: an AI/ML functional entity for processing an AI/ML related operation triggered by a functional unit or a group of functional units, associated with an AI/ML functional entity, inside the first device; an AI/ML functional entity for processing an AI/ML related operation triggered by a functional unit other than a functional unit or a group of functional units, associated with an AI/ML functional entity, inside the first device; or an AI/ML functional entity capable of processing both an AI/ML related operation triggered by a functional unit or a group of functional units, associated with an AI/ML functional entity, inside the first device and an AI/ML related operation triggered by a functional unit other than a functional unit or a group of functional units, associated with an AI/ML functional entity, inside the first device; or
in a case that the type of the functional entity for processing the AI/ML related operation is determined based on the type of the AI/M L related operation capable of being processed, different types of AI/ML functional entities support different task sets of AI/ML related operations.

6. The communications device according to claim 1, wherein the first device further performs following operation:
receiving a second message transmitted by the second device,
wherein the second message comprises second AI/ML related capability information, the second AI/ML related capability information is associated with the second device, the second AI/ML related capability information comprises S pieces of information, and S is a positive integer; and
the S pieces of information are used to indicate at least one of following: whether a functional entity for processing an AI/ML related operation is deployed for the second device, whether the second device supports a capability of on-demand configuration of a functional entity for processing an AI/ML related operation, whether the second device supports a capability of data collection for an AI/M L purpose, whether the second device supports a capability of data reporting for an AI/ML purpose, whether the second device supports a capability of data measurement for an AI/ML purpose, whether the second device supports a capability of offline AI/ML model training, whether the second device supports a capability of online AI/ML model training, AI/ML model running or an AI/ML model compiling format supported by the second device, whether the second device supports a reasoning capability of an AI/ML model, whether the second device supports a handover capability of an AI/ML model, whether the second device supports an activation capability or a deactivation capability of an AI/ML model, whether the second device supports a performance monitoring capability of an AI/ML model, whether the second device supports a transmission capability of an AI/ML model, or whether the second device supports an update capability of an AI/ML model, wherein
a reporting granularity for part of or all of the S pieces of information comprises at least one of following: a granularity based on the second device, a granularity based on a functional unit comprised in the second device, or a granularity based on an identity of the AI/ML model.

7. The communications device according to claim 6, wherein the transmission capability of the AI/ML model comprises a data transmission format of the AI/ML model.

8. The communications device according to claim 1, wherein the first device further performs following operation:
transmitting a third message to the second device,
wherein the third message comprises capability update indication information, and the capability update indication information is used to indicate that the first AI/ML related capability information is updated, wherein
the capability update indication information comprises a sixth bit, and the sixth bit is used to indicate that the first AI/ML related capability information is updated; or
the capability update indication information comprises a plurality of bits, wherein each bit of the plurality of bits is associated with a piece of or a group of pieces of AI/ML related capability information, and each bit is used to indicate whether the piece of or the group of pieces of AI/ML related capability information corresponding to respective bit is updated.

9. The communications device according to claim 8, wherein the first device further performs following operations:
receiving a fourth message transmitted by the second device, wherein the fourth message is used to instruct the first device to report the updated first AI/M L related capability information, or the fourth message is used to instruct the first device to report updated capability information in the first AI/ML related capability information, the fourth message comprises capability type indication information, and the capability type indication information is used to indicate a type of the updated capability information reported by the first device; and
transmitting a fifth message to the second device, wherein the fifth message comprises the updated first AI/ML related capability information, or the fifth message comprises updated capability information specified by the second device for reporting.

10. A communications device, wherein the communications device is a second device, the second device comprises a processor and a memory, the memory is configured to store a computer program, and the processor is configured to invoke the computer program stored from the memory and run the computer program, to cause the second device to perform following operation:
receiving a first message transmitted by a first device,
wherein the first message comprises first artificial intelligence AI/machine learning ML related capability information, the first AI/ML related capability information is associated with the first device, the first AI/M L related capability information comprises M pieces of information, and M is a positive integer; and
the M pieces of information are used to indicate at least one of following: whether a functional entity for processing an AI/ML related operation is deployed for the first device, whether the first device supports a capability of on-demand configuration of a functional entity for processing an AI/ML related operation, whether the first device supports a capability of data collection for an AI/ML purpose, whether the first device supports a capability of data reporting for an AI/ML purpose, whether the first device supports a capability of data measurement for an AI/M L purpose, whether the first device supports a capability of offline AI/ML model training, whether the first device supports a capability of online AI/ML model training, AI/ML model running or an AI/ML model compiling format supported by the first device, whether the first device supports a reasoning capability of an AI/ML model, whether the first device supports a handover capability of an AI/ML model, whether the first device supports an activation capability or a deactivation capability of an AI/ML model, whether the first device supports a performance monitoring capability of an AI/ML model, whether the first device supports a transmission capability of an AI/ML model, or whether the first device supports an update capability of an AI/ML model.

11. The communications device according to claim 10, wherein
the M pieces of information comprise third information, and the third information is used to indicate whether the first device supports the capability of data collection for the AI/ML purpose, wherein the third information comprises:
a third bit, wherein the third bit is used to indicate whether the first device as a whole supports the capability of data collection for the AI/ML purpose, and the third information is associated with a type of collected data, wherein the type of collected data associated with the third information is agreed upon by a protocol, or the type of collected data associated with the third information is indicated by an information field comprised in the third information; or
n₃ groups of sub-information, wherein each group of sub-information in the n₃ groups of sub-information comprises one or more bits, each group of the sub-information is associated with a functional unit or a group of functional units inside the first device, and n₃ is a positive integer, wherein
in a case that each group of the sub-information comprises one bit, an i^{th} group of sub-information is used to indicate whether a functional unit or a group of functional units, associated with the i^{th} group of sub-information, inside the first device supports the capability of data collection for the AI/ML purpose; or
in a case that each group of the sub-information comprises at least two bits, each group of the sub-information comprises a tenth information field and an eleventh information field, a tenth information field comprised in an i^{th} group of sub-information is used to indicate whether a functional unit or a group of functional units, associated with the i^{th} group of sub-information, inside the first device supports the capability of data collection for the AI/ML purpose, and an eleventh information field comprised in the i^{th} group of sub-information is used to indicate a set of types of collected data; or
in a case that each group of the sub-information comprises at least one bit, each group of the sub-information comprises a twelfth information field, and a twelfth information field comprised in an i^{th} group of sub-information is used to indicate whether a functional unit or a group of functional units, associated with the i^{th} group of sub-information, inside the first device supports the capability of data collection for the AI/ML purpose, and indicate a set of types of collected data; or
in a case that each group of the sub-information comprises at least one bit, an i^{th} group of sub-information is used to indicate a set of types of data collected by a functional unit or a group of functional units, associated with the i^{th} group of sub-information, inside the first device;
wherein i is a positive integer, and 1≤i≤n₃.

12. The communications device according to claim 10, wherein
the M pieces of information comprise fourth information, and the fourth information is used to indicate whether the first device supports the capability of data reporting for the AI/ML purpose, wherein the fourth information comprises:
a fourth bit, wherein the fourth bit is used to indicate whether the first device as a whole supports the capability of data reporting for the AI/ML purpose, and the fourth information is associated with a type of reported data, wherein the type of reported data associated with the fourth information is agreed upon by a protocol, or the type of reported data associated with the fourth information is indicated by an information field comprised in the fourth information; or
n₄ groups of sub-information, wherein each group of sub-information in the n₄ groups of sub-information comprises one or more bits, each group of the sub-information is associated with a functional unit or a group of functional units inside the first device, and n₄ is a positive integer, wherein
in a case that each group of the sub-information comprises one bit, an i^{th} group of sub-information is used to indicate whether a functional unit or a group of functional units, associated with the i^{th} group of sub-information, inside the first device supports the capability of data reporting for the AI/ML purpose; or
in a case that each group of the sub-information comprises at least two bits, each group of the sub-information comprises a fourteenth information field and a fifteenth information field, a fourteenth information field comprised in an i^{th} group of sub-information is used to indicate whether a functional unit or a group of functional units, associated with the i^{th} group of sub-information, inside the first device supports the capability of data reporting for the AI/M L purpose, and a fifteenth information field comprised in the i^{th} group of sub-information is used to indicate a set of types of reported data; or
in a case that each group of the sub-information comprises at least one bit, each group of the sub-information comprises a sixteenth information field, and a sixteenth information field comprised in an i^{th} group of sub-information is used to indicate whether a functional unit or a group of functional units, associated with the i^{th} group of sub-information, inside the first device supports the capability of data reporting for the AI/ML purpose, and indicate a set of types of reported data; or
in a case that each group of the sub-information comprises at least one bit, an i^{th} group of sub-information is used to indicate a set of types of data reported by a functional unit or a group of functional units, associated with the i^{th} group of sub-information, inside the first device;
wherein i is a positive integer, and 1≤i≤n₄.

13. The communications device according to claim 10, wherein
the M pieces of information comprise fifth information, and the fifth information is used to indicate whether the first device supports the capability of data measurement for the AI/ML purpose, wherein the fifth information comprises:
a fifth bit, wherein the fifth bit is used to indicate whether the first device as a whole supports the capability of data measurement for the A l/M L purpose, and the fifth information is associated with a type of measured data, wherein the type of measured data associated with the fifth information is agreed upon by a protocol, or the type of measured data associated with the fifth information is indicated by an information field comprised in the fifth information; or
n₅ groups of sub-information, wherein each group of sub-information in the n₅ groups of sub-information comprises one or more bits, each group of the sub-information is associated with a functional unit or a group of functional units inside the first device, and n₅ is a positive integer, wherein
in a case that each group of the sub-information comprises one bit, an i^{th} group of sub-information is used to indicate whether a functional unit or a group of functional units, associated with the i^{th} group of sub-information, inside the first device supports the capability of data measurement for the A l/M L purpose; or
in a case that each group of the sub-information comprises at least two bits, each group of the sub-information comprises an eighteenth information field and a nineteenth information field, an eighteenth information field comprised in an i^{th} group of sub-information is used to indicate whether a functional unit or a group of functional units, associated with the i^{th} group of sub-information, inside the first device supports the capability of data measurement for the AI/ML purpose, and a nineteenth information field comprised in the i^{th} group of sub-information is used to indicate a set of types of measured data; or
in a case that each group of the sub-information comprises at least one bit, each group of the sub-information comprises a twentieth information field, and a twentieth information field comprised in an i^{th} group of sub-information is used to indicate whether a functional unit or a group of functional units, associated with the i^{th} group of sub-information, inside the first device supports the capability of data measurement for the A l/M L purpose, and indicate a set of types of measured data; or
in a case that each group of the sub-information comprises at least one bit, an i^{th} group of sub-information is used to indicate a set of types of data measured by a functional unit or a group of functional units, associated with the i^{th} group of sub-information, inside the first device;
wherein i is a positive integer, and 1≤i≤n₅.

14. The communications device according to claim 10, wherein
the M pieces of information comprise sixth information, and the sixth information is used to indicate whether the first device supports the capability of offline AI/ML model training;
the sixth information is associated with offline AI/ML model training type indication information, wherein a bit status value of the offline AI/ML model training type indication information is used to indicate that the first device supports only offline AI/ML model training triggered by the first device, or a bit status value of the offline AI/ML model training type indication information is used to indicate that the first device supports only offline AI/ML model training triggered by the second device, or a bit status value of the offline AI/ML model training type indication information is used to indicate that the first device supports both offline AI/ML model training triggered by the first device and offline AI/ML model training triggered by the second device; and
the offline AI/ML model training type indication information associated with the sixth information is agreed upon by a protocol, or the offline AI/ML model training type indication information associated with the sixth information is indicated by an information field in the sixth information.

15. The communications device according to claim 10, wherein
the M pieces of information comprise seventh information, and the seventh information is used to indicate whether the first device supports the capability of online AI/ML model training;
the seventh information is associated with online AI/ML model training type indication information, wherein a bit status value of the online AI/ML model training type indication information is used to indicate that the first device supports only online AI/ML model training triggered by the first device, or a bit status value of the online AI/ML model training type indication information is used to indicate that the first device supports only online AI/ML model training triggered by the second device, or a bit status value of the online AI/ML model training type indication information is used to indicate that the first device supports both online AI/ML model training triggered by the first device and online AI/ML model training triggered by the second device; and
the online AI/ML model training type indication information associated with the seventh information is agreed upon by a protocol, or the online AI/ML model training type indication information associated with the seventh information is indicated by an information field in the seventh information.

16. The communications device according to claim 10, wherein the M pieces of information comprise eighth information, and the eighth information is used to indicate the AI/ML model running or the AI/ML model compiling format supported by the first device.

17. The communications device according to claim 10, wherein the M pieces of information comprise ninth information, and the ninth information is used to indicate whether the first device supports the reasoning capability of the AI/ML model;
the ninth information is associated with AI/ML model reasoning type indication information, wherein a bit status value of the AI/ML model reasoning type indication information is used to indicate that the first device supports only non-federated reasoning or centralized reasoning, or a bit status value of the AI/ML model reasoning type indication information is used to indicate that the first device supports only federated reasoning or distributed reasoning, or a bit status value of the AI/ML model reasoning type indication information is used to indicate that the first device supports federated reasoning and non-federated reasoning; and
the AI/ML model reasoning type indication information associated with the ninth information is agreed upon by a protocol, or the AI/ML model reasoning type indication information associated with the ninth information is indicated by an information field in the ninth information.

18. The communications device according to claim 10, wherein the M pieces of information comprise twelfth information, and the twelfth information is used to indicate whether the first device supports the performance monitoring capability of the AI/ML model;
the twelfth information is associated with AI/ML model performance monitoring type indication information, wherein a bit status value of the AI/ML model performance monitoring type indication information is used to indicate that performance monitoring of the AI/ML model is allowed to be performed only by the first device, or a bit status value of the AI/ML model performance monitoring type indication information is used to indicate that performance monitoring of the AI/ML model is allowed to be performed only by the second device, or a bit status value of the AI/ML model performance monitoring type indication information is used to indicate that performance monitoring of the AI/ML model is allowed to be performed by the first device or the second device; and
the AI/ML model performance monitoring type indication information associated with the twelfth information is agreed upon by a protocol, or the AI/ML model performance monitoring type indication information associated with the twelfth information is indicated by an information field in the twelfth information.

19. The communications device according to claim 10, wherein the M pieces of information comprise thirteenth information, and the thirteenth information is used to indicate whether the first device supports the transmission capability of the AI/ML model;
the thirteenth information is associated with AI/ML model transmission type indication information, wherein a bit status value of the AI/ML model transmission type indication information is used to indicate that the first device supports only downloading of the AI/ML model, or a bit status value of the AI/ML model transmission type indication information is used to indicate that the first device supports only uploading of the AI/ML model, or a bit status value of the AI/ML model transmission type indication information is used to indicate that the first device supports both downloading of the AI/ML model and uploading of the AI/ML model; and
the AI/ML model transmission type indication information associated with the thirteenth information is agreed upon by a protocol, or the AI/ML model transmission type indication information associated with the thirteenth information is indicated by an information field in the thirteenth information.

20. The communications device according to claim 10, wherein
a reporting granularity for part of or all of the M pieces of information comprises at least one of following: a granularity based on the first device, a granularity based on a functional unit comprised in the first device, or a granularity based on an identity of the AI/ML model.
